(19) United States
(12) Patent Application Publication
(10) Pub. No.: US 2017/0064489 A1
(43) Pub. Date: Mar. 2, 2017

(54) NETWORK SYSTEM, METHOD FOR DETERMINING COMMUNICATION QUALITY, AND ANALYSIS APPARATUS

(71) Applicant: HITACHI, LTD., Tokyo (JP)

(72) Inventors: Naoki TANIDA, Tokyo (JP); Takashi ISOBE, Tokyo (JP)

(73) Assignee: HITACHI, LTD., Tokyo (JP)

(21) Appl. No.: 15/230,818

(22) Filed: Aug. 8, 2016

(30) Foreign Application Priority Data
Aug. 25, 2015 (JP) 2015-165909

(51) Int. Cl. H04W 4/00; H04L 29/08

(52) U.S. Cl. CPC H04W 4/005; H04L 67/12; H04W 84/12

(57) ABSTRACT

A network system including a plurality of network apparatuses comprises an analysis part configured to analyze a communication status of a communication flow which is a control unit of a communication between terminals. The analysis part includes a reception process part configured to generate and update flow information, and a degradation point identifying part configured to detect degradation of communication quality of the each of the plurality of communication flows. The degradation point identifying part includes an index calculating part configured to calculate a plurality of indexes that are similar to a packet loss rate, the plurality of indexes requiring a smaller amount of data for an analysis and therefore requiring a shorter period of time for calculation. The degradation point identifying part determines whether communication quality of the communication flow has degraded or not based on the indexes.

### CLAIM OF PRIORITY

The present application claims priority from Japanese patent application JP 2015-165909 filed on Aug. 25, 2015, the content of which is hereby incorporated by reference into this application.

### BACKGROUND OF THE INVENTION

The present invention relates to an assessment method of communication quality.

A large number of communication relay points such as Wi-Fi access points and mobile base stations are installed at many locations to broaden the communication network areas. In order to maintain the convenience of communications by preventing a reduction in communication speed and communication stability, which is caused by degradation of communication quality, it is necessary to check the communication relay point that is causing the degradation of communication quality.

However, if a maintenance worker is delegated to the relay point to assess the communication quality on-site, the maintenance cost would increase, and because it would take a long time for the maintenance worker to be physically there, it would not be possible to immediately fix the problem using a communication apparatus when degradation of the communication quality occurred. In addition, the number of communication gateways managed by providers has increased due to the wide spread of Machine to Machine (M2M)/Internet of Things (IoT), and therefore, it is difficult to identify a point where the cause of the communication quality degradation is present.

The background arts of the technical field of the present invention include Japanese Patent Application Laid-open Publication No. 2006-246118.

Japanese Patent Application Laid-open Publication No. 2006-246118 discloses “a quality degradation identification method of single-point observation type in a packet exchange network that measures communication quality by monitoring one point (observation point) between a sender and a receiver in a communication configured to retransmit data when the data is discarded so as to ensure the reliable data transfer using the function of communication protocol or the function of an application located at a level higher than the communication protocol, the method comprising: a flow extraction step in which flows (from the start to end of a communication between sender and destination terminals) to be subjected to the measurement are extracted from packet header information; an NW quality estimation step in which the end-to-end NW quality is estimated by estimating a position where a packet loss or delay occurred and operating a counter corresponding to a section to which the packet belongs among counters installed in respective sequence sections that are obtained by dividing a space made of sequence number; and a degradation point determining step in which it is determined whether the degradation point is closer to the sender terminal or the destination terminal from the observation point, using information of the counter that has been operated, wherein, when TCP protocol is used, the NW quality estimation step includes: determining that the packet loss has occurred on the flow when ACK having the same sequence number is transmitted from the destination terminal more frequently than a prescribed threshold; searching an area of the maximum window size in the stored data for a corresponding packet; and increasing the value of the counter that corresponds to the location where the packet loss has occurred.”

### SUMMARY OF THE INVENTION

In the method of Patent Document 1, an area of the maximum window size in the stored data is searched to determine the presence or absence of the corresponding packet in this area, and the value of the counter corresponding to the point where the loss has occurred is increased. This method has a problem of not being able to perform an on-memory process when the communication size of the observation point is large, as well as a problem of not being able to determine the degradation point in each of the large number of communication flows in real-time.

The present invention can be appreciated by the description which follows in conjunction with the following figures, wherein: a network system comprises a plurality of network apparatuses, wherein each of the plurality of network apparatuses includes a processing device, and a storage device coupled to the processing device. The network system comprises: a transfer function part configured to transfer packets that flow through a communication flow which is a control unit of a communication between terminals; and an analysis part configured to analyze a communication status of the communication flow. The transfer function part and the analysis part are realized by the processing device of at least one of the plurality of network apparatuses executing programs stored in the storage device. The analysis part includes a reception process part configured to receive packets belonging to a given communication flow from the transfer function part, and generate and update flow information that is management information on the communication flow based on an analysis result of header information on the packets, a communication status of flow storage part configured to store the flow information on each of a plurality of communication flows, and a degradation point identifying part configured to detect degradation of communication quality of the each of the plurality of communication flows, and identify a degradation point on a communication path of the communication flow having quality degradation. The degradation point identifying part includes an index calculating part configured to calculate a plurality of indexes that are similar to a packet loss rate, the plurality of indexes requiring a smaller amount of data for an analysis and therefore requiring a shorter period of time for calculation. The degradation point identifying part is configured to determine whether communication quality of the communication flow has degraded or not based on the plurality of indexes calculated by the index calculating part, and identify the degradation point on a communication path which is gone through a communication flow having degradation in the communication quality, based on the plurality of indexes calculated by the index calculating part.

According to one aspect of the present invention, it is possible to assess communication quality of communication flows and identify the degradation point in real-time. The problems, configurations, and effects other than those described above will become apparent by the descriptions of embodiments below.

### BRIEF DESCRIPTION OF THE DRAWINGS

The present invention can be appreciated by the description which follows in conjunction with the following figures, wherein:

FIG. 1 is a diagram for explaining a configuration example of a network system of a first embodiment;

FIG. 2 is a block diagram showing an example of the hardware configuration and software configuration of an analysis apparatus of the first embodiment;

FIG. 3 is a diagram showing a format of a mirror packet sent to the analysis apparatus of the first embodiment;

FIG. 4 is a block diagram showing the relationships between respective function parts of the analysis apparatus and a transfer apparatus of the first embodiment;

FIG. 5 is a diagram showing a flow of the process performed by each function of the analysis apparatus of the first embodiment;

FIG. 6 is a diagram showing an example of a session_data structure of the first embodiment;

FIG. 7 is a diagram showing an example of a capture_data structure of the first embodiment;

FIG. 8 is a diagram showing an example of an analysis_data structure of the first embodiment;

FIG. 9 is a diagram showing the relationship between the session_data structure, the capture_data structures, and the analysis_data structure of the first embodiment;

FIG. 10 is a diagram showing an arrangement example of the session_data structure in a communication status of flow storage part of the first embodiment;

FIG. 11 is a diagram showing data structure of the network configuration information stored in a network configuration information storage part of the first embodiment;

FIG. 12 is a diagram showing data structure of the communication quality degradation status information stored in a communication quality degradation status storage part of the first embodiment;

FIG. 13 is a flowchart for explaining in detail the process performed by a reception process part of the first embodiment;

FIG. 14 is a flowchart for explaining in detail the process performed by a degradation point identifying part of the first embodiment;

FIG. 15 is a diagram for explaining the determining method of quality degradation determining process of the first embodiment;

FIG. 16 is a diagram showing transition status of a part of flow information of the first embodiment;

FIG. 17 is a diagram showing the relationship between a non-accumulative data loss rate and a packet retransmission rate of the communication flow in the first embodiment;

FIG. 18 is a flowchart for explaining in detail the process performed by a low-quality network identifying part of the first embodiment;

FIG. 19 is a diagram showing an example of communication quality degradation status information output by the communication quality degradation status storage part of the first embodiment;

FIG. 20 is a block diagram showing the relationship between the respective function parts of the analysis apparatus and the transfer apparatus of a second embodiment;

FIG. 21 is a diagram showing an example of capture_data structure of the second embodiment;

FIG. 22 is a diagram showing an example of analysis_data structure of the second embodiment;

FIG. 23 is a flowchart for explaining in detail the process performed by a reception process part of the second embodiment;

FIG. 24 is a flowchart for explaining in detail the process performed by a degradation point identifying part of the second embodiment;

FIG. 25 is a diagram for explaining a configuration example of a network system of a third embodiment;

FIG. 26 is a block diagram showing the relationship between the respective function parts of the analysis apparatus, the transfer apparatus 101, and a apparatus of the third embodiment;

FIG. 27 is a flowchart for explaining in detail the process performed by a communication flow extracting part 2610 of the third embodiment; and

FIG. 28 is a block diagram showing the relationship between the respective function parts of the transfer apparatus of a fourth embodiment.

### DETAILED DESCRIPTION OF THE EMBODIMENTS

Below, embodiments of the present invention will be explained in detail with reference to the appended figures. It should be noted that the respective embodiments are merely examples to implement the present invention, and do not limit the technical scope of the present invention. In the respective figures, the same configurations are given the same reference characters.

### First Embodiment

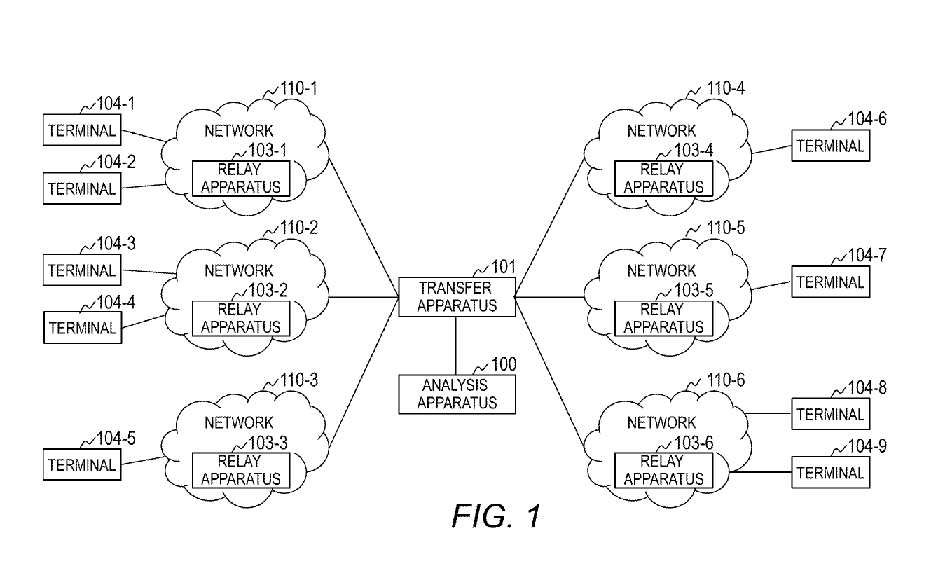

In first embodiment, the basic example of the present invention will be explained. FIG. 1 is a diagram for explaining a configuration example of a network system of the first embodiment.

The network system of the first embodiment includes an analysis apparatus 100, a transfer apparatus 101, a plurality of networks 110 including at least one relay apparatus 103, and a plurality of terminals 104.

The analysis apparatus 100 is connected to the transfer apparatus 101. The transfer apparatus 101 is connected to the plurality of networks 110. The terminals 104 are connected to the transfer apparatus 101 via the networks 110, respectively. Some of the terminals 104 are also connected to another terminal via the network 110.

In the example shown in FIG. 1, the terminals 104-1 and 104-2 are connected to the transfer apparatus 101 via the network 110-1. The terminals 104-3 and 104-4 are connected to the transfer apparatus 101 via the network 110-2. The terminal 104-5 is connected to the transfer apparatus 101 via the network 110-3. The terminal 104-6 is connected to the transfer apparatus 101 via the network 110-4. The terminal 104-7 is connected to the transfer apparatus 101 via the network 110-5. The terminals 104-8 and 104-9 are connected to the transfer apparatus 101 via the network 110-6.

The networks 110-1, 110-2, 110-3, 110-4, 110-5, and 110-6 respectively include the relay apparatuses 103-1, 103-2, 103-3, 103-4, 103-5, and 103-6. Examples of the relay apparatus 103 include a switch, a gateway device, and the like.

The transfer apparatus 101 transfers the packets transmitted from the terminal 104 to the network 110. The packets transferred to the network 110 are transferred to the terminal 104 by the relay apparatus 103. The transfer apparatus 101 has a function for generating mirror packets. The transfer apparatus 101 transmits the generated mirror packets to the analysis apparatus 100.

The analysis apparatus 100 analyzes the header information of packets belonging to communication flows that go through the transfer apparatus 101, which is the integration point of the communication networks, and detects degradation of communication quality of communication flows. The analysis apparatus 100 includes an index calculating part that calculates a plurality of indexes for determining communication quality of communication flows.

Specifically, the analysis apparatus 100 calculates a plurality of indexes based on the observation results of the mirror packets. The analysis apparatus 100 uses the plurality of indexes to identify a point (network 110) where the cause of the degradation of communication quality exists on the path of the communication flow. The analysis apparatus 100 also identifies a point (network 110) where the cause of the degradation of communication flow exists in the entire network system based on the evaluation results of the communication quality of a plurality of communication flows.

In the description below, a point where the cause of the degradation of communication quality exists on the path through the communication flow will also be referred to as a degradation point of the flow, and a point where the cause of the degradation of communication quality exists in the entire network will also be referred to as a degradation point of the network system.

The indexes calculated by the analysis apparatus 100 of the first embodiment have the following features. First, in the calculation process of the indexes, the size of data necessary for analysis is smaller than that of the packet loss rate, which makes it possible to perform the calculation faster. Second, it is possible to evaluate the effect of the loss of packets that belong to the communication flow. That is, the indexes are similar to the packet loss rate, but the size thereof necessary for the analysis is smaller than that of the packet loss rate, which reduces the time required for calculation. In the first embodiment, the non-accumulative data loss rate and packet retransmission rate are used as the indexes having such features.

The non-accumulative data loss rate is the packet loss rate that includes a specific type of data, and is based only on the first packets transmitted from the sender terminal 104. In the non-accumulative data loss rate, the packets that were retransmitted from the sender terminal 104 or the transfer apparatus 101 are not taken into consideration. Thus, it is possible to reduce the size of data necessary for the analysis, and to perform the real-time calculation due to the reduction in analysis load. That is, the calculation load can be reduced.

The packet retransmission rate is a rate of the packets that are retransmitted to the sender terminal 104. The packet retransmission rate can be calculated by counting the number of packets retransmitted to the sender terminal 104 due to a packet loss. Thus, it is possible to reduce the size of data necessary for the analysis, and to perform the real-time calculation due to the reduction in analysis load.

As described below, using the non-accumulative data loss rate and packet retransmission rate, the analysis apparatus 100 determines which one of the communication path between the sender terminal 104 and the transfer apparatus 101 and the communication path between the destination terminal 104 and the transfer apparatus 101 corresponds to the degradation point of the flow.

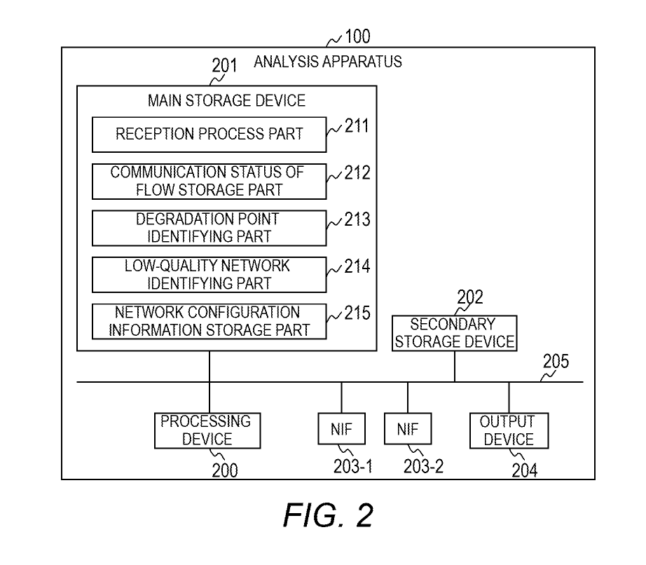

FIG. 2 is a block diagram showing an example of the hardware configuration and software configuration of the analysis apparatus 100 of the first embodiment.

The analysis apparatus 100 includes, as the hardware, a processing device 200, a main storage device 201, a secondary storage device 202, a plurality of NIFs 203, and an output device 204. The processing device 200, the main storage device 201, the secondary storage device 202, the plurality of NIFs 203, and the output device 204 are connected to each other via a system bus 205. The respective devices may be connected to each other via a plurality of system buses 205, or connected directly to each other.

The processing device 200 executes programs stored in the main storage device 201. Examples of the processing device 200 include CPU and GPU. The functions of the analysis apparatus 100 are realized by the processing device 200 executing the programs. Below, when a process is explained as being performed by a function part, that means the processing device 200 is executing the program that realizes such a function part.

The main storage device 201 stores therein programs to be executed by the processing device 200 and data necessary for executing those programs. The main storage device 201 has storage areas such as a work area to be used by each program, a buffer, and the like. The programs stored in the main storage device 201 will be explained in detail below.

The secondary storage device 202 stores therein programs and data. The programs and data stored in the main storage device 201 may alternatively be stored in the secondary storage device 202. In that case, the processing device 200 reads out the programs and data from the secondary storage device 202, and loads the programs and data onto the main storage device 201.

The NIF 203 is an interface for connecting with another device. The analysis apparatus 100 of this embodiment includes two NIFs 203-1 and 203-2 connected to the transfer apparatus 101. In a case of receiving mirror packets from the transfer apparatus 101, the NIFs 203 outputs the received mirror packets to a receiving process part 211 to be described later.

The output device 204 is an interface that outputs the process results of the analysis apparatus 100 and the like. Examples of the output device 204 include a display, touch panel, or the like that displays the process results. The output device 204 may also be implemented as an NIF that sends the process results to another device. The output device 204 may be realized as an output function. In this embodiment, there is no specific limitation on the implementation method of the output device 204.

The transfer apparatus 101 has a hardware configuration similar to that of the analysis apparatus 100.

Next, the programs stored in the main storage device 201 will be explained. The main storage device 201 of this embodiment stores therein programs that realize a reception process part 211, a communication status of flow storage part 212, a degradation point identifying part 213, a low-quality network identifying part 214, and a network configuration information storage part 215. The main storage device 201 may also store other programs.

The reception process part 211 processes mirror packets received from the transfer apparatus 101 and data stored in the communication status of flow storage part 212, and stores the process results in the communication status of flow storage part 212.

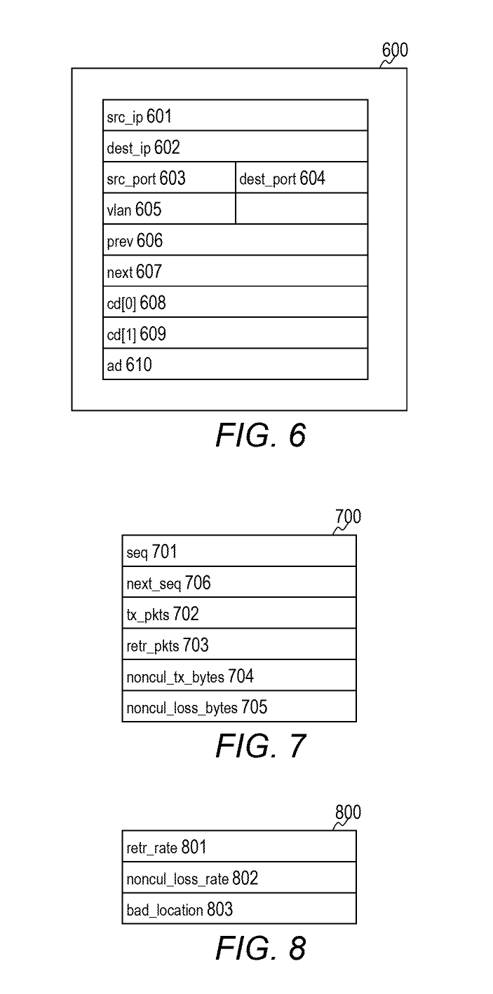

The communication status of flow storage part 212 stores therein flow information, which is management information on the communication flows. The flow information includes information that indicates the communication status of each communication flow. The reception process part 211, the degradation point identifying part 213, and the low-quality network identifying part 214 read out the flow information stored in the communication status of flow storage part 212, and write data in the communication status of flow storage part 212. The flow information will be explained in detail with reference to FIGS. 6 to 10.

The degradation point identifying part 213 calculates the non-accumulative data loss rate and the packet retransmission rate of each communication flow, using the flow information stored in the communication status of flow storage part 212. The degradation point identifying part 213 then determines whether the communication quality has degraded or not in each communication flow, using the non-accumulative data loss rate and the packet transmission rate. The degradation point identifying part 213 identifies whether there is the cause of communication quality degradation in both the sender and the receiver of the communication flow, based on the determination results. That is, the degradation point of the flow is identified. The results of the process performed by the degradation point identifying part 213 are stored in the communication status of flow storage part 212.

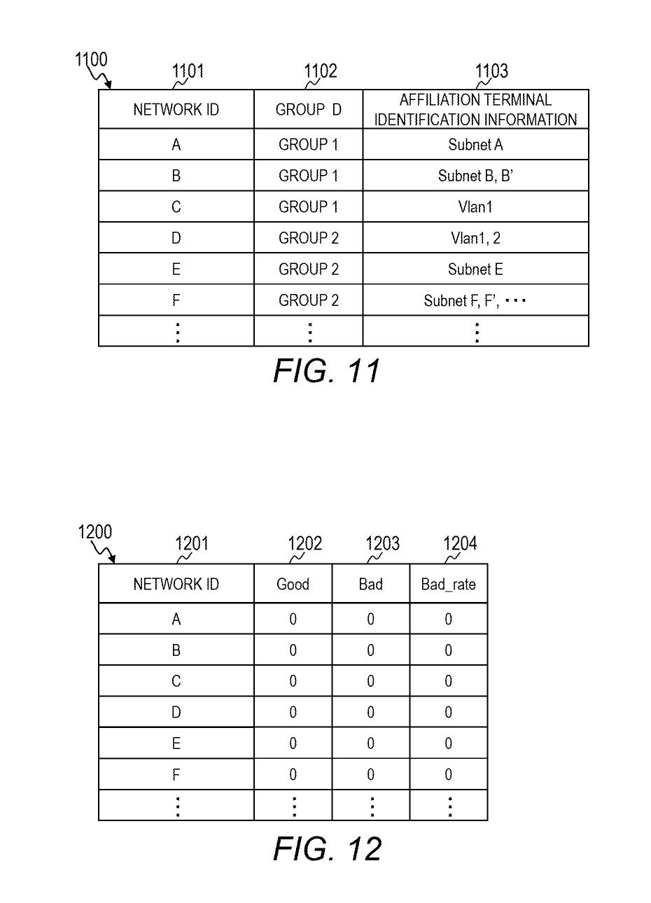

The network configuration information storage part 215 stores therein network configuration information, which is the information related to the network configuration of the communication flows that go through the transfer apparatus 101. In this embodiment, the network configuration information is stored in advance. The network configuration information may also be automatically generated by the reception process part 211 or the like based on the mirror packets received from the transfer apparatus 101. The network configuration information will be explained in detail with reference to FIG. 11.

The low-quality network identifying part 214 identifies a point where the cause of degradation of communication quality exists in the network system, using the flow information stored in the communication status of flow storage part 212 and the network configuration information stored in the network configuration information storage part 215. That is, the degradation point of the network system is identified. The results of the process performed by the low-quality network identifying part 214 are stored in a communication quality degradation status storage part 432 in the low-quality network identifying part 214.

A part or all of the reception process part 211, communication status of flow storage part 212, degradation point identifying part 213, low-quality network identifying part 214, and network configuration information storage part 215 may be installed in one or a plurality of pieces of hardware that include the processing device 200, NIFs 203, and output device 204. It is also possible to use a logical NIF realized with one physical NIF.

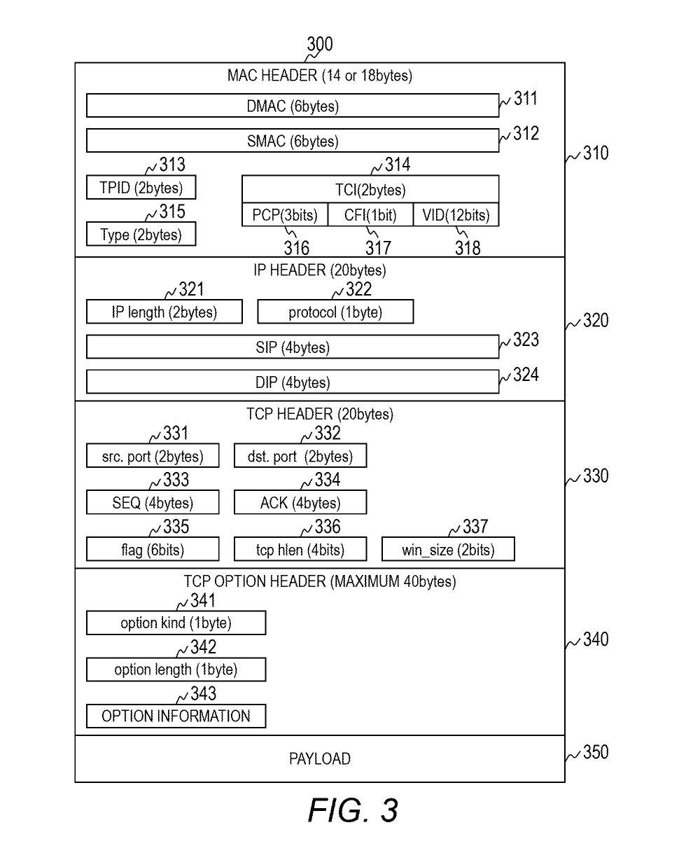

FIG. 3 is a diagram showing the format of a mirror packet sent to the analysis apparatus 100 of the first embodiment.

The packet 300 includes a MAC header 310, an IP header 320, a TCP header 330, a TCP option header 340, and a payload 350.

The MAC header 310 includes a DMAC 311, a SMAC 312, a TPID 313, a TCI 314, and a Type 315.

The DMAC 311 indicates the destination MAC address. The SMAC 312 indicates the sender MAC address. The TPID 313 indicates a frame with tag, and the type of the tag. The TCI 314 indicates the tag information. The Type 315 indicates the MAC frame type.

The TCI 314 includes a PCP 316, a CFI 317, and a VID 318. The PCP 316 indicates a priority. The CFI 317 indicates whether the MAC address is in a normal form or not. The VID 318 indicates the ID of VLAN. If VLAN is not used in the network, the TPID 313 and the TCI 314 are omitted. In this case, the analysis apparatus 100 puts “0” in VID.

The IP header 320 includes an IP length 321, a protocol 322, a SIP 323, and a DIP 324.

The IP length 321 indicates the length of the packet excluding MAC header 310. The protocol 322 indicates the protocol number. The SIP 323 indicates the sender IP address. The DIP 324 indicates the destination IP address.

The TCP header 330 includes a src.port 331, a dst.port 332, a SEQ 333, an ACK 334, a flag 335, a tcp hlen 336, and a win_size 337.

The src.port 331 indicates the sender port number. The dst.port 332 indicates the destination port number. The SEQ 333 indicates the sender sequence number. The ACK 334 indicates the receiver sequence number. The flag 335 indicates the TCP flag number. The tcp hlen 336 indicates the header length of TCP. The win_size 337 indicates a size of an advertised window sent to the counterpart apparatus.

The TCP option header 340 includes 0 or a plurality of options such as an option kind 341, an option length 342, and an option information 343. The option kind 341 indicates a type of an option, the option length 342 indicates a length of the option, and the option information 343 indicates the information corresponding to the type of the option.

For example, a maximum segment size (MSS) option is used to notify the counterpart apparatus of the receivable MSS size of the own apparatus at the start of the TCP communication. A selective acknowledgement (SACK) option is used to notify the counterpart apparatus that the own apparatus is compatible with the SACK option at the start of the TCP communication. The SACK option is also used to notify the counterpart apparatus of the position of the data that was partially received when a loss of packets was detected during communication. A time stamp option is used to notify the counterpart apparatus of the reception time of the own apparatus during communication. A window scale option is used to notify the counterpart apparatus of a bit number that right-shifts the value provided by win_size 337 in order to increase the maximum value of the size of the advertised window that can be sent to the counterpart apparatus. As described above, the TCP option header 340 is used to notify the counterpart apparatus of the available functions and information of the own apparatus during or at the start of communication.

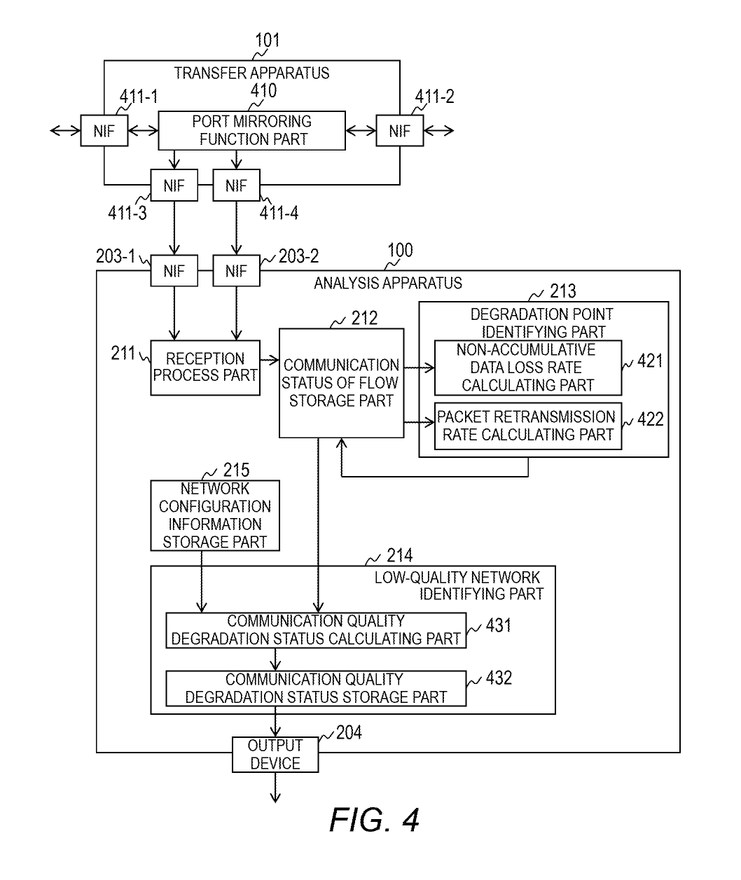

FIG. 4 is a block diagram showing the relationships between the respective function parts of the analysis apparatus 100 and the transfer apparatus 101 of the first embodiment.

The transfer apparatus 101 has four NIFs 411-1, 411-2, 411-3, and 411-4, and includes a port mirroring function part 410. The port mirroring function part 410 transfers to the NIF 411-2 the packets received through the NIF 411-1, and sends mirror packets that are identical to the received packets to the analysis apparatus 100 through the NIF 411-3. The port mirroring function part 410 transfers to the NIF 411-1 the packets received through the NIF 411-2, and sends mirror packets that are identical to the received packets to the analysis apparatus 100 through the NIF 411-4.

The NIFs 203-1 and 203-2 output the mirror packets received from the transfer apparatus 101 to the reception process part 211.

In a case where the packets are input from the NIF 203-1, the reception process part 211 determines that the packets were sent from the NIF 411-1 to the NIF 411-2. In a case where the packets are input from the NIF 203-2, the reception process part 211 determines that the packets were sent from the NIF 411-2 to the NIF 411-1. The reception process part 211 determines whether the flow information of the communication flow to which the packets corresponding to the mirror packets belong is stored in the communication status of flow storage part 212 or not, based on the header information of the mirror packets input from the NIF 203.

In a case where the information is stored in the communication status of flow storage part 212, the reception process part 211 analyzes the information and the header information of mirror packets stored in the communication status of flow storage part 212, and updates the flow information stored in the communication status of flow storage part 212.

In a case where the information is not stored in the communication status of flow storage part 212, the reception process part 211 analyzes the header information of the mirror packets, and stores the new flow information in the communication status of flow storage part 212. By processing the header information of mirror packets only, the process load can be reduced, and this method can be applied to communications with encrypted payload.

The communication status of flow storage part 212 receives an update operation of the flow information in parallel from the reception process part 211, the degradation point identifying part 213, and the low-quality network identifying part 214. By allowing the reception process part 211, the degradation point identifying part 213, and the low-quality network identifying part 214 to perform processes in parallel, the process speed of the analysis apparatus 100 can be improved.

The degradation point identifying part 213 includes a non-accumulative data loss rate calculating part 421 and a packet retransmission rate calculating part 422 as index calculating parts. The non-accumulative data loss rate calculating part 421 and packet retransmission rate calculating part 422 respectively calculate the non-accumulative data loss rate and packet retransmission rate of each communication flow, based on each of a plurality of pieces of the flow information stored in the communication status of flow storage part 212. The non-accumulative data loss rate and packet retransmission rate may alternatively be calculated by a single index calculating part.

The degradation point identifying part 213 determines whether the communication quality of a communication flow has degraded or not based on the non-accumulative data loss rate and packet retransmission rate. In a case where the communication quality has degraded, the degradation point identifying part 213 identifies the degradation point of the flow based on the results of the process using the non-accumulative data loss rate and packet retransmission rate, and stores the results in the communication status of flow storage part 212.

The low-quality network identifying part 214 includes a communication quality degradation status calculating part 431 and a communication quality degradation status storage part 432.

The communication quality degradation status calculating part 431 obtains the process results of the degradation point identifying part 213 from the each of the plurality of pieces of the flow information stored in the communication status of flow storage part 212. The communication quality degradation status calculating part 431 maps the obtained process results in the network configuration information stored in the network configuration information storage part 215 in order to generate communication quality degradation status information. The communication quality degradation status calculating part 431 stores the generated communication quality degradation status information in the communication quality degradation status storage part 432.

The network configuration information storage part 215 stores therein the network configuration information. The network configuration information includes a list of networks, identification criteria for respective networks, and information indicating whether the network is closer to the NIF 411-1 or the NIF 411-2 from the transfer apparatus 101. The network configuration information is read out by the low-quality network identifying part 214, and used to generate the communication quality degradation status information.

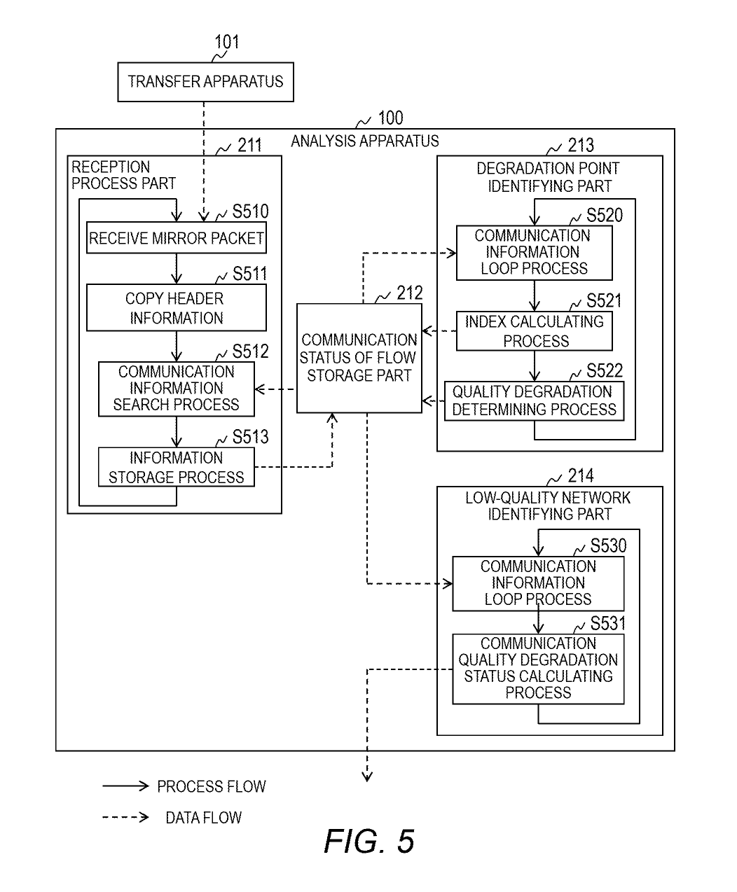

FIG. 5 is a diagram showing a flow of the process performed by each function of the analysis apparatus 100 of the first embodiment. The reception process part 211, the degradation point identifying part 213, and the low-quality network identifying part 214 operate in parallel.

First, the process flow of the reception process part 211 will be explained. In a case where mirror packets are receives from the transfer apparatus 101 (Step S510), the reception process part 211 copies only the header information of the mirror packets (Step S511).

The reception process part 211 performs a communication information searching process using the header information of the mirror packets and the flow information managed by the communication status of flow storage part 212 (Step S512), and performs an information storage process (Step S513).

Specifically, the reception process part 211 refers to the plurality of pieces of the flow information stored in the communication status of flow storage part 212, and searches for the flow information of the communication flow to which the packets corresponding to the received mirror packets belong. The reception process part 211 performs a prescribed process based on the search result and the header information of the mirror packets. The reception process part 211 stores the process results and a part of the head information of the mirror packets in the communication status of flow storage part 212.

Next, the process flow of the degradation point identifying part 213 will be explained. The degradation point identifying part 213 performs a communication information loop process (Step S520). Specifically, the degradation point identifying part 213 successively reads out the plurality of pieces of the flow information stored in the communication status of flow storage part 212.

The degradation point identifying part 213 performs an index calculating process on the each of the plurality of pieces of flow information (Step S521). Specifically, the non-accumulative data loss rate calculating part 421 and packet retransmission rate calculating part 422 respectively calculate the non-accumulative data loss rate and packet retransmission rate, which are indexes used to detect the degradation of communication quality. The calculated non-accumulative data loss rate and packet retransmission rate are fed back to the each of the plurality of pieces of flow information.

The degradation point identifying part 213 performs a quality degradation determining process using two types of indexes, which are the non-accumulative date loss rate and the packet loss rate (Step S522).

Specifically, the degradation point identifying part 213 determines whether the communication quality of the communication flow has degraded or not. In a case where it is determined that the communication quality of communication flow has degraded, the degradation point identifying part 213 determines whether the degradation point of the flow is present on the communication path between the sender terminal 104 and the transfer apparatus 101 or on the communication path between the destination terminal 104 and the transfer apparatus 101. Thereafter, the degradation point identifying part 213 stores a result of the process in the communication status of flow storage part 212. On the other hand, in a case where it is determined that the communication quality of communication flow has not degraded, the degradation point identifying part 213 stores a result of process indicating that the communication quality of the communication flow has not degraded in the communication status of flow storage part 212.

Next, the process flow of the low-quality network identifying part 214 will be explained. The low-quality network identifying part 214 performs a communication information loop process (Step S530). Specifically, the low-quality network identifying part 214 successively reads out the plurality of pieces of flow information stored in the communication status of flow storage part 212.

The low-quality network identifying part 214 performs a communication quality degradation status calculating process using the flow information stored in the communication status of flow storage part 212 and the network configuration information stored in the network configuration information storage part 215 (Step S531).

Specifically, the communication quality degradation status calculating part 431 feeds back the determination result of the degradation point identifying part 213, which is included in the flow information, to the network configuration information, thereby generating the communication quality degradation status information. The communication quality degradation status calculating part 431 also stores the communication quality degradation status information in the communication quality degradation status storage part 432.

Next, the data structure of the flow information stored in the communication status of flow storage part 212 will be explained with reference to FIGS. 6 to 10. In the description below, the group of network 110 connected to the NIF 411-1 of the transfer apparatus 101 will be referred to as Group 1, and the group of network 110 connected to the NIF 411-2 will be referred to as Group 2. The terminal 104 connected to the network 110 included in Group 1 will be referred to as the terminal 104 of Group 1, and the terminal 104 connected to the network 110 included in Group 2 will be referred to as the terminal 104 of Group 2.

The flow information stored in the communication status of flow storage part 212 is made up of three different types of data structures, which are a session_data structure 600, a capture_data structure 700, and an analysis_data structure 800. The session_data structure 600 is the fundamental information for managing the communication flow. The capture_data structure 700 is the information for managing the communication status or the like of the communication flow. The capture_data structure 700 is updated by the reception process part 211 when mirror packets are received. The analysis_data structure 800 is the information for managing the analysis results of communication flow. The analysis_data structure 800 is mainly updated by the degradation point identifying part 213.

FIG. 6 is a diagram showing an example of the session_data structure 600 of the first embodiment.

The reception process part 211 generates the session_data structure 600 as shown in FIG. 6 for each communication flow.

The session_data structure 600 includes a src_ip 601, a dest_ip 602, a src_port 603, a dest_port 604, a vlan 605, a prev 606, a next 607, a cd [0] 608, a cd [1] 609, and an ad 610.

The src_ip 601 is the IP address of the terminal 104 of Group 1, and the dest_ip 602 is the IP address of the terminal 104 of Group 2. The src_port 603 is the port number of the terminal 104 of Group 1, and the dest_port 604 is the port number of the terminal 104 of Group 2.

The vlan 605 is the vlan number, the prev 606 and the next 607 are pointer variables for the session_data structure 600, and the cd [0] 608 and the cd [1] 609 are pointer variables for the capture_data structure 700, which will be explained later. The ad 610 is a pointer variable for the analysis_data structure 800, which will be explained later.

FIG. 7 is a diagram showing an example of the capture_data structure 700 of the first embodiment.

The reception process part 211 generates two capture_data structures 700 for one communication flow. Specifically, the capture_data structure 700 for the packets sent from the terminal 104 of Group 1 to the terminal 104 of Group 2, and the capture_data structure 700 for the packets sent from the terminal 104 of Group 2 to the terminal 104 of Group 1 are generated.

The capture_data structure 700 includes a seq 701, a next_seq 706, tx_pkts 702, a retr_pkts 703, a noncul_tx_bytes 704, and a noncul_loss_bytes 705.

The seq 701 is the last sequence number of the mirror packets that have been received so far. The next_seq 706 is an estimated value of the sequence number included in the mirror packet that will be received next. The tx_pkts 702 is the number of mirror packets that have been received so far. The retr_pkts 703 is the number of packets retransmitted by TCP protocol among the mirror packets that have been received so far.

The noncul_tx_bytes 704 is the total value of the payload size of the packets, excluding the retransmission packets. The noncul_loss_bytes 705 is the total value of the payload size of the packets that were discarded at least once.

FIG. 8 is a diagram showing an example of the analysis_data structure 800 of the first embodiment. The analysis_data structure 800 is mainly updated by the degradation point identifying part 213.

The analysis_data structure 800 includes a retr_rate 801, a noncul_loss_rate 802, and a bad_location 803.

The retr_rate 801 is the packet retransmission rate, the noncul_loss_rate 802 is the non-accumulative data loss rate, and the bad_location 803 is a value that indicates the degradation point of the flow.

In this embodiment, the value of bad_location 803 is either “0,” “1,” or “2.” “0” indicates that there is not the degradation point of the flow. “1” indicates that the communication path between the sender terminal 104 and the transfer apparatus 101 is the degradation point of the flow. “2” indicates that the communication path between the destination terminal 104 and the transfer apparatus 101 is the degradation point of the flow.

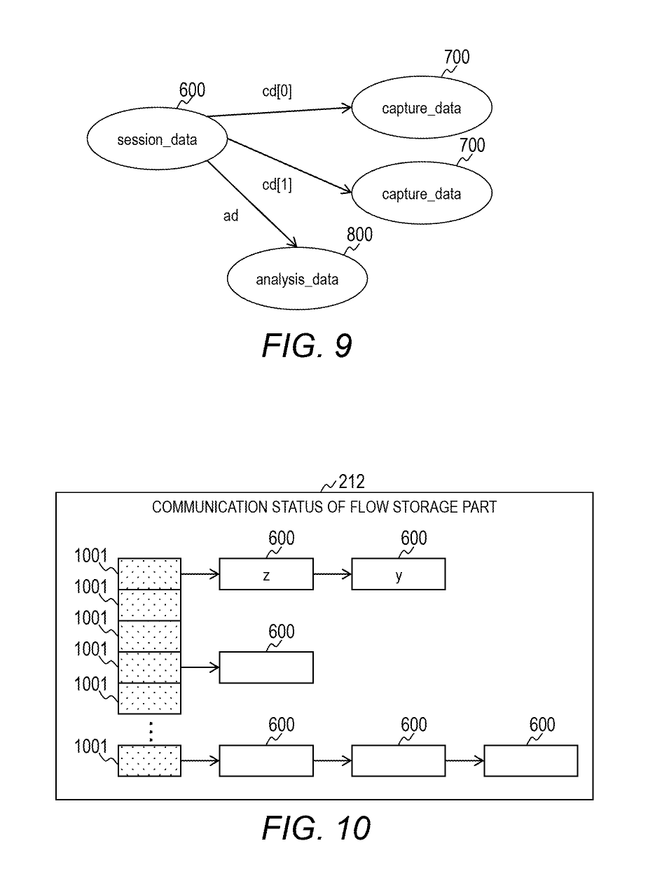

FIG. 9 is a diagram showing the relationship between the session_data structure 600, the capture_data structures 700, and the analysis_data structure 800 of the first embodiment.

In a case where a communication via a new communication flow is started, the reception process part 211 generates one session_data structure 600, two capture_data structures 700 for the differing transmission directions of packets flowing in the communication flow, and one analysis_data structure 800.

The reception process part 211 updates the capture_data structures 700 in a case where the information of the communication flow exists in the communication status of flow storage part 212, and in a case where new mirror packets that flow through the communication flow are received.

The capture_data structure 700 for the packets transmitted from the terminal 104 of Group 1 to the terminal 104 of Group 2 is indicated by cd[0] 608 of the session_data structure 600. The capture_data structure 700 for the packets transmitted from the terminal 104 of Group 2 to the terminal 104 of Group 1 is indicated by cd[ 1] 609 of the session_data structure 600. The analysis_data structure 800 is indicated by ad 610 of the session_data structure 600.

FIG. 10 is a diagram showing an arrangement example of the session_data structure 600 in the communication status of flow storage part 212 of the first embodiment.

The communication status of flow storage part 212 holds the flow information by the open hush table structure. The open hush table structure is represented as an array of pointers 1001 for pointing at the session_data structures 600 each of which stores the management information of the respective communication flows. The number of array is two million, for example. Each session_data structure 600 includes prev 606 and next 607 as pointers pointing at other session_data structures 600.

The relationship between the session_data structure 600 of each communication flow and the pointer 1001 is determined by the following method. The value obtained by applying the hush function md5 to the bit string combining five values of src_ip 601, dest_ip 602, src_port 603, dest_port 604 and vlan 605 is divided by the number of elements in the array, thereby deriving the remainder x. The x-th pointer 1001 of the array is defined as the pointer that indicates the session_data structure 600. Furthermore, prev 606 of the session_data structure 600 is defined so as to indicate the address of the x-th pointer 1001 of the array.

Here, the case in which the remainder calculated from the session_data structure 600y is x, and the x-th pointer 1001 is already set to point at another session_data structure 600z. In this case, next 607 of the session_data structure 600z is set to point at the session_data structure 600y, and prev 606 of the session_data structure 600y is set to point at the session_data structure 600z.

FIG. 11 is a diagram showing the data structure of the network configuration information 1100 stored in the network configuration information storage part 215 of the first embodiment.

The network configuration information storage part 215 stores therein the network configuration information 1100 as a table including a plurality of rows. One row is made up of network an ID 1101, a group ID 1102, and an affiliation terminal identification information 1103.

The network ID 1101 is identification information for uniquely identifying each network 110 in the network system. The group ID 1102 is identification information for uniquely identifying each group that includes the network 110. In this embodiment, either “Group 1” or “Group 2” is stored in the group ID 1102.

The affiliation terminal identification information 1103 is information for identifying the terminal 104 connected to the network 110. The affiliation terminal identification information 1103 of this embodiment includes one or a plurality of pieces of identification information of subnet, or one or a plurality of pieces of identification information on vlan. The affiliation terminal identification information 1103 may also includes combined information of the identification information of subnet and the identification information of vlan, tag information used for encapsulation other than vlan, tag information indicating the network identified by the encapsulation other than vlan, and the like.

The analysis apparatus 100 can detect a communication path of communication flows on the network system, using the network configuration information 1100. For example, if the SIP 323 of a certain mirror packet is the IP address of Subnet A, and the DIP 324 is the IP address of Subnet E, the analysis apparatus 100 determines that the communication path of the communication flow to which the packets corresponding to the mirror packets belong is the communication path that goes through the network 110 with the identification information “A” and the network 110 with the identification information “E.”

FIG. 12 is a diagram showing the data structure of the communication quality degradation status information 1200 stored in the communication quality degradation status storage part 432 of the first embodiment.

The communication quality degradation status storage part 432 stores the communication quality degradation status information 1200 as a table that includes a plurality of rows. One row is made up of a network ID 1201, a Good 1202, a Bad 1203, and a Bad_rate 1204.

The network ID 1201 is the same as the network ID 1101. The Good 1202 is the number of communication flows deemed to have no degradation of communication quality among the communication flows that go through the network 110. Bad 1203 is the number of communication flows deemed to have degradation of communication quality among the communication flows that go through the network 110. Bad_rate 1204 is the ratio of the communication flows deemed to have degradation of communication quality among the plurality of the communication flows flowing the network which corresponds to the network ID 1201.

Each column in each row of the communication quality degradation status information 1200 sets “0” as an initial value. That is, the communication quality degradation status information 1200 of FIG. 12 shows the initialized state.

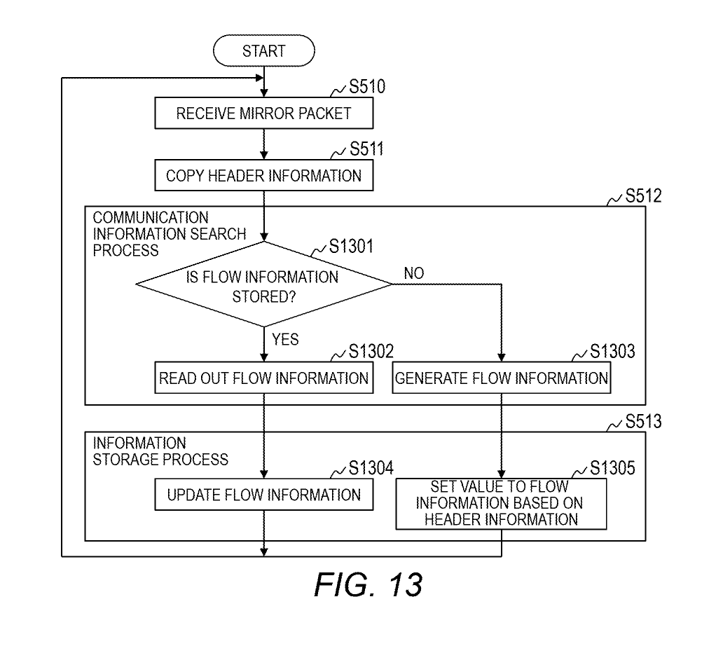

FIG. 13 is a flowchart for explaining in detail the process performed by the reception process part 211 of the first embodiment. The reception process part 211 starts the following processes after the analysis apparatus 100 is activated. The timing at which the reception process part 211 starts the process is not limited to this embodiment.

In a case where the reception process part 211 receives mirror packets from the transfer apparatus 101 (Step S510), the reception process part 211 copies the header information of the received mirror packets to the main storage device 201 (Step S511). By copying only the header information to the main storage device 201, the usage of the main storage device 201 can be reduced, and the process speed can be increased.

Next, the reception process part 211 starts the communication information searching process (Step S512).

In the communication information searching process, the reception process part 211 searches for the flow information of the communication flow to which the packets corresponding to the received mirror packets belong, among the plurality of pieces of the flow information stored in the communication status of flow storage part 212. The reception process part 211 determines whether the flow information is stored in the communication status of flow storage part 212 or not based on the search result (Step S1301). Specifically, the process described below is performed.

In a case of mirror packets received by the NIF 203-1, the reception process part 211 determines whether the session_data structure 600 fulfilling the following conditions exists or not: the src_ip 601 matches the SIP 323; the dest_ip 602 matches the DIP 324; the src_port 603 matches the src.port 331; the dest_port 604 matches the dst.port 332; and the vlan 605 matches the VID 318. In a case where the session_data structure 600 that fulfills those conditions exists, the reception process part 211 determines that the flow information of the communication flow to which the packets corresponding to the mirror packets belong is stored in the communication status of flow storage part 212.

In a case of mirror packets received by the NIF 203-2, the reception process part 211 determines whether the session_data structure 600 fulfilling the following conditions exists or not: the src_ip 601 matches the DIP 324; the dest_ip 602 matches the SIP 323; the src_port 603 matches the dst.port 332; the dest_port 604 matches the src.port 331; and the vlan 605 matches the VID 318. In a case where the session_data structure 600 that fulfills those conditions exists, the reception process part 211 determines that the flow information of the communication flow to which the packets corresponding to the mirror packets belong is stored in the communication status of flow storage part 212.

The determining conditions differ between the NIF 203-1 and the NIF 203-2 because the transmission directions of the packets that flow the same communication flow differ. The process of Step S1301 is performed as described above.

In a case where the flow information of the communication flow to which the packets corresponding to the mirror packets belong is stored in the communication status of flow storage part 212, the reception process part 211 reads out the flow information found in the communication status of flow storage part 212 (Step S1302). Thereafter, the reception process part 211 starts the information storage process (Step S513). In the information storage process, the reception process part 211 updates the flow information that was found (Step S1304). Then, the reception process part 211 returns to Step S510. The process of Step S1304 is performed as described below.

First, the reception process part 211 adds “1” to tx_pkts 702 of the capture_data structure 700.

If SEQ 333 of the header information is the number that follows seq 701 of the capture_data structure 700, the reception process part 211 adds the payload length of the mirror packets to noncul_tx_bytes 704. If SEQ 333 of the header information is the number ahead of seq 701 of the capture_data structure 700, the reception process part 211 adds “1” to retr_pkts 703.

If SEQ 333 of the header information is greater than next_seq 706 of the capture_data structure 700, then that means that the data having the capacity calculated by the following equation (1) is discarded. Thus, the reception process part 211 adds the capacity calculated by the equation (1) to noncul_loss_bytes 705.

[Equation 1]

(SEQ333)−(next_seq706) (1)

The reception process part 211 sets SEQ 333 of the header information in seq 701 of the capture_data structure 700. The reception process part 211 sets the value calculated by the following equation (2) in next_seq 706. The value calculated by the equation (2) represents the estimated value of SEQ 333 of the packet to be received next by the analysis apparatus 100 when packets are not discarded. The process of Step S1304 is performed as described above.

[Equation 2]

(SEQ333)+{(payload length)+1} (2)

In a case where it is determined that the flow information of the communication flow to which the packets corresponding to the mirror packets belong is not stored in the communication status of flow storage part 212 in Step S1301, the reception process part 211 generates flow information and stores the flow information in the communication status of flow storage part 212 (Step S1303). Thereafter, the reception process part 211 starts the information storage process (Step S513). In the information storage process, the reception process part 211 sets values of the newly generated flow information based on the header information (Step S1305). Then, the reception process part 211 returns to Step S510. The process of Step S1305 is performed as described below.

The reception process part 211 sets “1” in tx_pkts 702, and sets the payload length of the mirror packets in noncul_tx_bytes 704. The reception process part 211 also sets “0” in retr_pkts 703, and in noncul_loss_bytes 705. The reception process part 211 also sets the value calculated by the equation (2) in next_seq 706. The process of Step S1305 is performed as described above.

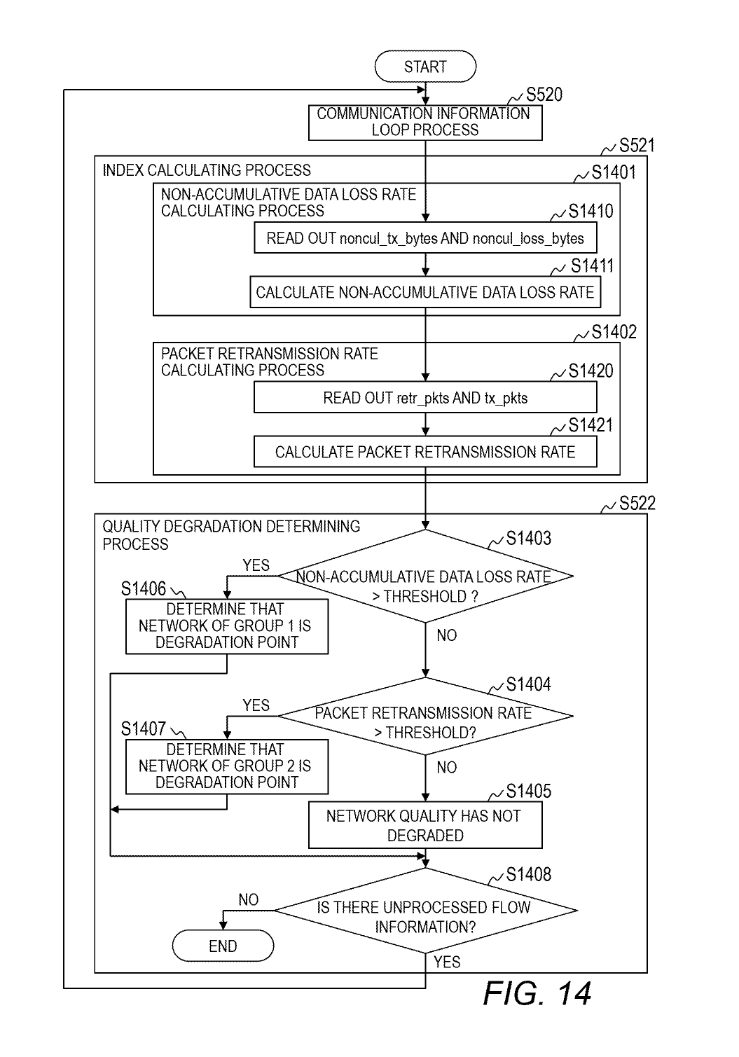

FIG. 14 is a flowchart for explaining in detail the process performed by the degradation point identifying part 213 of the first embodiment. The degradation point identifying part 213 starts the following process periodically, or when the flow information is updated or instruction is received from an administrator or the like. The timing at which the degradation point identifying part 213 starts the process is not limited to this embodiment.

The degradation point identifying part 213 performs a communication information loop process (Step S520). Specifically, the degradation point identifying part 213 selects target flow information among the plurality of pieces of the flow information stored in the communication status of flow storage part 212.

Next, the degradation point identifying part 213 starts the index calculating process using the selected flow information (Step S521). In the index calculating process, the non-accumulative data loss rate and the packet retransmission rate are respectively calculated (Steps S1401 and S 1402).

In the process of calculating the non-accumulative data loss rate, first, the non-accumulative data loss rate calculating part 421 reads out noncul_tx_bytes 704 and noncul_loss_bytes 705 of the selected flow information (Step S1410). The non-accumulative data loss rate calculating part 421 calculates the non-accumulative data loss rate based on the following equation (3) (Step S1411). In this process, the non-accumulative data loss rate calculating part 421 stores the calculated non-accumulative data loss rate in noncul_loss_rate 802 of the selected flow information in the communication status of flow storage part 212.

$$\begin{matrix}[ Equation 3 ] & \\ \frac{noncul\_loss \_bytes 705}{noncul\_tx \_bytes704} & ( 3 )\end{matrix}$$

In the process of calculating the packet retransmission rate, first, the packet retransmission rate calculating part 422 reads out tx_pkts 702 and retr_pkts 703 of the selected flow information from the communication status of flow storage part 212 (Step S1420). The packet retransmission rate calculating part 422 calculates the packet retransmission rate based on the following equation (4) (Step S1421). In this process, the packet retransmission rate calculating part 422 stores the calculated packet retransmission rate in the retr_rate 801 of the selected flow information in the communication status of flow storage part 212.

$$\begin{matrix}[ Equation 4 ] & \\ \frac{retr\_pkts703}{tx\_pkts702} & ( 4 )\end{matrix}$$

The index calculating process is performed as described. Next, the degradation point identifying part 213 starts the quality degradation determining process using the calculated non-accumulative data loss rate and packet retransmission rate (Step S522).

In the quality degradation determining process, first, the degradation point identifying part 213 reads out noncul_loss_rate 802 of the selected flow information from the communication status of flow storage part 212, and determines whether the non-accumulative data loss rate is greater than a prescribed threshold value or not (Step S1403).

In a case where the non-accumulative data loss rate is greater than the prescribed threshold value, the degradation point identifying part 213 determines that the communication quality of the communication flow has degraded, and that the degradation point is the network 110 of Group 1 (communication path between the sender terminal 104 and the transfer apparatus 101) (Step S1406). Then the degradation point identifying part 213 proceeds to Step S1408. The degradation point identifying part 213 stores “1” in bad_location 803 of the selected flow information in the communication status of flow storage part 212.

In a case where the non-accumulative data loss rate is equal to or smaller than the prescribed threshold value, the degradation point identifying part 213 reads out retr_rate 801 of the selected flow information from the communication status of flow storage part 212, and determines whether the packet retransmission rate is greater than a prescribed threshold value or not (Step S1404).

In a case where the packet retransmission rate is greater than the prescribed threshold value, the degradation point identifying part 213 determines that the communication quality of the communication flow has degraded, and that the degradation point is the network 110 of Group 2 (communication path between the destination terminal 104 and the transfer apparatus 101) (Step S1407). Then the degradation point identifying part 213 proceeds to Step S1408. The degradation point identifying part 213 stores “2” in bad_location 803 of the selected flow information in the communication status of flow storage part 212.

In a case where the packet retransmission rate is equal to or smaller than the prescribed threshold value, the degradation point identifying part 213 determines that the communication quality of the communication flow has not degraded (Step S1405). Then the degradation point identifying part 213 proceeds to Step S1408. The degradation point identifying part 213 stores “0” in bad_location 803 of the selected flow information in the communication status of flow storage part 212.

In Step S1408, the degradation point identifying part 213 determines whether or not there is flow information that has not been processed among the plurality of pieces of the flow information stored in the communication status of flow storage part 212 (Step S1408).

In a case where unprocessed flow information is found, the degradation point identifying part 213 returns to Step S520, and performs the processes described above. In a case where unprocessed flow information is not found, the degradation point identifying part 213 ends the process. In this case, the degradation point identifying part 213 enters a stand-by state until a prescribed period of time has passed or an instruction is received.

The threshold values used in the determining process of Step S1403 and the determining process of Step S1404 are greater than 0 and smaller than 1. For example, “0.01” is used for the threshold values. The threshold values used for the respective determining processes may differ from each other, or may be the same. The quality degradation determining process is performed as described above.

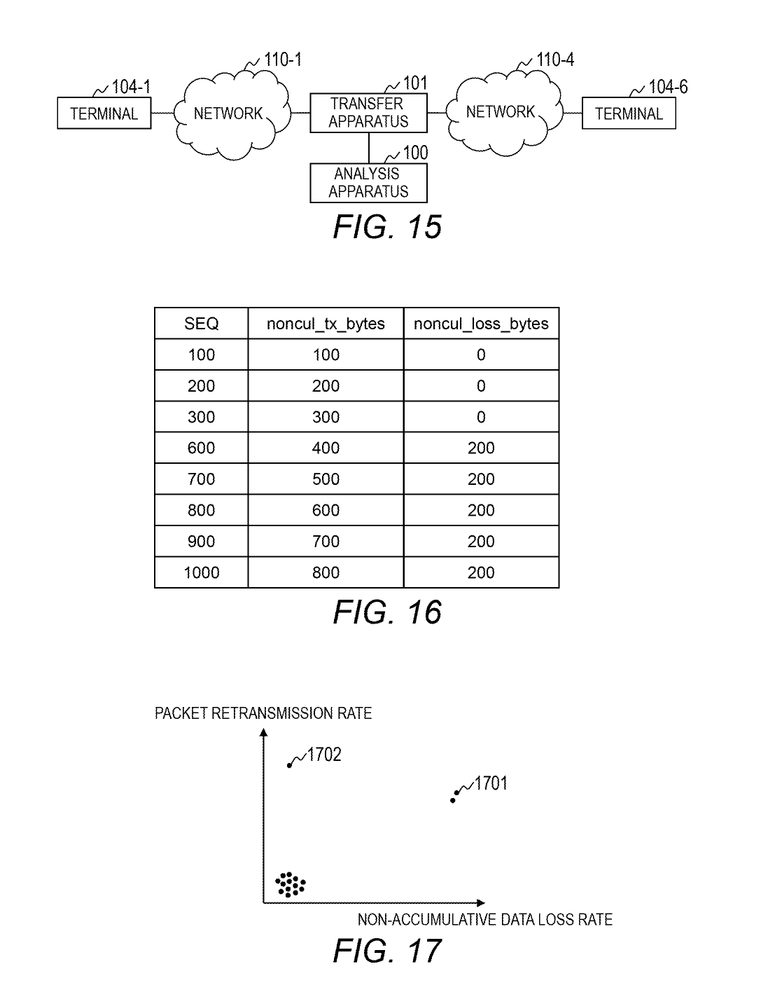

Next, the method to identify the degradation point using the non-accumulative data loss rate and packet retransmission rate will be explained with reference to FIG. 15.

FIG. 15 is a diagram for explaining the determining method of the quality degradation determining process of the first embodiment. FIG. 16 is a diagram showing the transition status of a part of the flow information of the first embodiment. For convenience of explanation, the communication flow to transmit data from the terminal 104-1 to the terminal 104-6 will be explained as an example. In the description, the network 110-1 corresponds to the network 110 of Group 1, and the network 110-4 corresponds to the network 110 of Group 2.

First, how the identification method for the degradation point using the non-accumulative data loss rate works will be explained.

A case in which the terminal 104-1 has transmitted ten packets in which SEQ 333 are “100,” “200,” “300,” “400,” “500,” “600,” “700,” “800,” “900,” and “1000,” respectively, will be explained as an example. The payload length of each packet is “100.” In this case, when the transfer apparatus 100 receives the packet in which SEQ 333 is “300,” the reception process part 211 stores “400” in next_seq 706 of the flow information.

In a case where the two packets in which SEQ 333 are respectively “400” and “500” are discarded in the network 110-1, the transfer apparatus 101 receives the packet in which SEQ 333 is “600” after receiving the packet in which SEQ 333 is “300.” At this time, the reception process part 211 calculates the value “200” based on the equation (1), and stores “200” in noncul_loss_bytes 705 of the flow information. Thereafter, when the transfer apparatus 101 receives the packets in which SEQ 333 is respectively “700,” “800,” “900,” and “1000,” the analysis apparatus 100 has observed eight packets, and therefore, noncul_tx_bytes 704 of the flow information is “800.” FIG. 16 shows noncul_tx_bytes 704 and noncul_loss_bytes 705 when each packet was received.

In this case, the non-accumulative data loss rate is “0.25” as calculated by the following equation (5).

$$\begin{matrix}[ Equation 5 ] & \\ noncul\_loss \_rate802 = \frac{200}{800} = 0.25 & ( 5 )\end{matrix}$$

On the other hand, when the two packets in which SEQ 333 is “400” and “500” are discarded in the network 110-4, because the transfer apparatus 101 has received all packets from the terminal 104-1, noncul_loss_bytes 705 is “0,” and noncul_tx_bytes 704 is “1000.” In this case, the non-accumulative data loss rate is “0” as calculated by equation (6).

$$\begin{matrix}[ Equation 6 ] & \\ noncul\_loss \_rate802 = \frac{0}{1000} & ( 6 )\end{matrix}$$

As described above, the non-accumulative data loss rate is calculated based on the byte count of the packets that the transfer apparatus 101 could not receive in the order of SEQ 333, and therefore, when the packet was discarded in the network 110-1, the value of non-accumulative data loss rate increases. On the other hand, the non-accumulative data loss rate is not affected by the packet loss in the network 110-4. Thus, the non-accumulative data loss rate can be used for a value indicating the communication quality of the communication flows that go through the network 110-1.

Next, how the identification method for the degradation point using the packet retransmission rate works will be explained.

A case in which the terminal 104-1 has transmitted ten packets in which SEQ 333 are “100,” “200,” “300,” “400,” “500,” “600,” “700,” “800,” “900,” and “1000,” respectively, will be explained as an example. The payload length of the packet is “100.”

When the two packets in which SEQ 333 are “400” and “500” are discarded in the network 110-4, tx_pkts 702 is “10.” In a case where the two packets in which SEQ 333 are “400” and “500” are retransmitted from the terminal 104-1, tx_pkts 702 is “12,” and retr_pkts 703 is “2.” Thus, the packet retransmission rate is calculated to be “0.167” in accordance with equation (4).

In a case where no confirmation is received from the destination terminal 104-6, then this means that a packet was discarded in either the network 110-1 or the network 110-4. In this case, regardless of the network 110 in which the packet was discarded, the sender terminal 104-1 retransmits the discarded packet. In a case where the transfer apparatus 101 receives the retransmitted packet, the analysis apparatus 100 updates retr_pkts 703.

In a case where the packet was discarded in the network 110-1, tx_pkts 702 is not updated. On the other hand, in a case where the packet was discarded in the network 110-4, tx_pkts 702 is updated.

The packet retransmission rate is a value calculated by dividing retr_pkts 703 by tx_pkts 702 as shown in equation (4). Thus, the packet retransmission rate is affected by the degradation of communication quality of both the network 110-1 and the network 110-4. Therefore, the packet retransmission rate can be used for a value indicating communication quality of the communication flows that go through the network 110-1 and the network 110-4.

If retr_pkts 703 is used for the index to determine the communication quality of the communication flow, the determining result would be affected by amount of the communication of the entire network, and therefore, in this embodiment, the packet retransmission rate is used for the index.

The degradation point identifying part 213 of this embodiment detects degradation of the communication quality and identifies the degradation point using two indexes that depend on the point where the packet is discarded as described above.

Specifically, the degradation point identifying part 213 determines whether the communication quality has degraded in the network 110-1 or not using the non-accumulative data loss rate (Step S1403). In a case where the non-accumulative data loss rate is equal to or smaller than a prescribed threshold value, the degradation point identifying part 213 determines whether the communication quality has degraded in the network 110-4 or not using the packet retransmission rate (Step S1404).

The packet retransmission rate is a value affected by the degradation of communication quality of both the network 110-1 and the network 110-4. However, because the degradation of communication quality of the network 110-1 was eliminated from the determining result based on the non-accumulative data loss rate, the degradation point identifying part 213 can determine the presence or absence of the degradation of communication quality of the network 110-4 based on the packet retransmission rate.

It is also possible that both of the network 110-1 and the network 110-4 are degradation points. In this case, by performing a determining process similar to above on the packet transmitted from the terminal 104-6 to the terminal 104-1, it is possible to determine that both of the networks 110 are degradation points. That is, the analysis apparatus 100 detects degradation of communication quality of the network 110-1 from the analysis results of the header information of the packet transmitted from the terminal 104-1 to the terminal 104-6 (Step S1406), and detects degradation of communication quality of the network 110-4 from the analysis results of the header information of the packet transmitted from the terminal 104-6 to the terminal 104-1 (Step S1406).

This allows the analysis apparatus 100 to address the case in which the cause of the degradation of communication quality exists in both of the sender and destination networks 110.

FIG. 17 is a diagram showing the relationship between the non-accumulative data loss rate and the packet retransmission rate of the communication flow in the first embodiment.

In FIG. 17, the vertical axis shows the packet retransmission rate of the communication flow, and the horizontal axis shows the non-accumulative data loss rate of the communication flow.

In a case where the non-accumulative data loss rate is greater than the threshold value, then that means that the sender network 110 is the degradation point. For example, in the communication flow shown in FIG. 15, in a case where the network 110-1 is the degradation point, the relationship between the non-accumulative rate and the packet retransmission rate of the communication flow is as indicated with the point 1701.

In a case where the non-accumulative data loss rate is equal to or smaller than the threshold value and the packet retransmission rate is greater than the threshold value, then that means that the destination network 110 is the degradation point. For example, in the communication flow shown in FIG. 15, in a case where the network 110-4 is the degradation point, the relationship between the non-accumulative rate and the packet retransmission rate of the communication flow is as indicated with the point 1702.

In a case where the non-accumulative data loss rate and the packet retransmission rate are both smaller than the threshold values, then that means that the communication quality of the communication flow has not degraded.

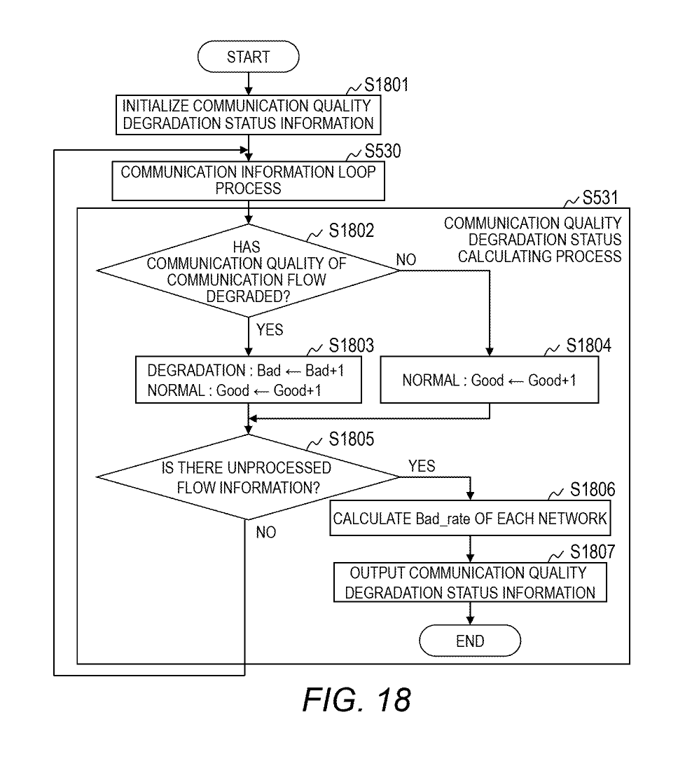

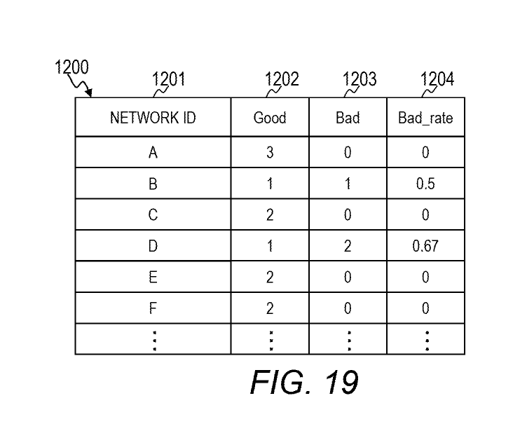

FIG. 18 is a flowchart for explaining in detail the process performed by the low-quality network identifying part 214 of the first embodiment. FIG. 19 is a diagram showing an example of the communication quality degradation status information 1200 output by the communication quality degradation status storage part 432 of the first embodiment.

The low-quality network identifying part 214 starts the process described below periodically, in a case where the degradation point identifying part 213 ends the process, in a case where an instruction is received from an administrator, or the like. The timing at which the low-quality network identifying part 214 starts the process is not limited to this embodiment.

The low-quality network identifying part 214 initializes the communication quality degradation status information 1200 stored in the communication quality degradation status storage part 432 (Step S1801). Specifically, the low-quality network identifying part 214 sets Good 1202, Bad 1203, and Bad_rate 1204 of all rows of the communication quality degradation status information 1200 to an initial value of “0” as shown in the communication quality degradation status information 1200 of FIG. 12.

Next, the low-quality network identifying part 214 performs the communication information loop process (Step S530). Specifically, the low-quality network identifying part 214 selects target flow information among a plurality of pieces of flow information stored in the communication status of flow storage part 212.

Next, the low-quality network identifying part 214 starts the communication quality degradation status calculating process (Step S531).

In the communication quality degradation status calculating process, first, the communication quality degradation status calculating part 431 determines whether the communication quality of communication flow that corresponds to the selected flow information has degraded or not, based on the selected flow information (Step S1802).

Specifically, the communication quality degradation status calculating part 431 determines whether “1” or “2” is set in bad_location 803 of the selected flow information or not. In a case where “1” or “2” is set in bad-location 803, the communication quality degradation status calculating part 431 determines that the communication quality of the communication flow has degraded.

In a case where it is determined that the communication quality of the communication flow corresponding to the flow information has degraded, the communication quality degradation status calculating part 431 adds “1” to Bad 1203 of the row that corresponds to the network 110 having the degradation point, and adds “1” to Good 1202 of the row that corresponds to the network 110 not having the degradation point (Step S1803). Thereafter, the communication quality degradation status calculating part 431 proceeds to Step S1805. Specifically, the process described below is performed.

The communication quality degradation status calculating part 431 identifies the sender network 110 and the destination network 110 of the communication flow based on the network configuration information 1100 and the session_data structure 600 of the flow information.

In a case where bad_location 803 of the flow information is set to “1,” the communication quality degradation status calculating part 431 adds “1” to Bad 1203 of the row that corresponds to the sender network 110, and adds “1” to Good 1202 of the row that corresponds to the destination network 110.

In a case where bad_location 803 of the flow information is set to “2,” the communication quality degradation status calculating part 431 adds “1” to Bad 1203 of the row that corresponds to the destination network 110, and adds “1” to Good 1202 of the row that corresponds to the sender network 110. The process of Step S1803 is performed as described above.

In a case where it is determined that the communication quality of the communication flow corresponding to the flow information has not degraded in Step S1802, the communication quality degradation status calculating part 431 adds “1” to Good 1202 of the rows that respectively correspond to the sender network 110 and the destination network 110 (Step S1804). Thereafter, the communication quality degradation status calculating part 431 proceeds to Step S1805. The method to identify the sender and destination networks 110 is the same as Step S1803.

In Step S1805, the communication quality degradation status calculating part 431 determines whether there is flow information that has not processed or not (Step S1805).

In a case where unprocessed flow information is found, the communication quality degradation status calculating part 431 returns to Step S530, and performs the processes described above.

In a case where unprocessed flow information is not found, the communication quality degradation status calculating part 431 calculates Bad_rate 1204 of each network 110 based on the communication quality degradation status information 1200 (Step S1806). Specifically, the communication quality degradation status calculating part 431 calculates Bad_rate 1204 using the following equation (7), and stores the calculated Bad_rate 1204 in the communication quality degradation status storage part 432.

$$\begin{matrix}[ Equation 7 ] & \\ Bad\_rate1024 = \frac{Bad 1203}{( Good 1202 ) + ( Bad 1203 )} & ( 7 )\end{matrix}$$

Here, seven communication flows from the first communication flow to the seventh communication flow are considered.

The first communication flow goes through the networks 110 having the network IDs 1201 of “A” and “D.” The second communication flow goes through the networks 110 having the network IDs 1201 of “A” and “E.” The third communication flow goes through the networks 110 having the network IDs 1201 of “A” and “F.” The fourth communication flow goes through the networks 110 having the network IDs 1201 of “B” and “D.” The fifth communication flow goes through the networks 110 having the network IDs 1201 of “B” and “E.” The sixth communication flow goes through the networks 110 having the network IDs 1201 of “C” and “D.” The seventh communication flow goes through the networks 110 having the network IDs 1201 of “C” and “F.”

For example, for the first communication flow and the sixth communication flow, the network 110 having the network ID 1201 of “D” is identified as the degradation point, and for the fourth communication flow, the network 110 having the network ID 1202 of “B” is identified as the degradation point. In this case, the communication quality degradation status information 1200 is updated to the status shown in FIG. 19. As shown in FIG. 19, Bad_rate 1204 of the networks 110 having the network IDs 1201 of “B” and “D” are greater than Bad_rate 1204 of other networks 110. The explanation returns to FIG. 18.

The communication quality degradation status storage part 432 outputs the updated communication quality degradation status information 1200 via the output device 204 (Step S1807). Then, the low-quality network identifying part 214 ends the process. Thereafter the low-quality network identifying part 214 enters a stand-by state until a prescribed period of time has passed or an instruction is received.

The communication quality degradation status information 1200 output through the output device 204 may be output as the graph format data as shown in FIGS. 1 and 15 or the table format data. The format of the data output from the output device 204 is not limited to this embodiment.

Bad_rate 1204 can be used for the index that represents the degree of degradation of the communication quality of the network 110 in the entire network system. In this way, the degradation point of the network system can be visualized.

The analysis apparatus 100 of the first embodiment performs the process using the mirror packets transmitted from the transfer apparatus 101 having the port mirroring function part 410, but may also perform a similar process using packets transmitted from the network tap.

In the first embodiment, TCP was explained as an example of the communication protocol, but the present invention is not limited to this. For example, as long as the communication protocol is configured to give a number to each packet to indicate the order of data transmission and reception, and has the function of retransmitting the discarded packets such as SCTP, the present invention can be applied.

According to the first embodiment, the analysis apparatus 100 can detect degradation of communication quality of a communication flow based on the non-accumulative data loss rate and the packet retransmission rate, which are indexes that are similar to the packet loss rate and that evaluate communication quality of a communication flow. Furthermore, the analysis apparatus 100 can identify, as the communication path having the cause of degradation of the communication quality, one of the communication path from the sender terminal 104 to the transfer apparatus 101 (network 110) and the communication path from the destination terminal 104 to the transfer apparatus 101 (network 110).

Also, according to the first embodiment, the analysis apparatus 100 can identify the degradation point (network 110) of the network system based on the determining results of the communication quality of a plurality of communication flows. The analysis apparatus 100 outputs the information indicating the identified point, thereby visualizing the degradation point of the network system. This allows the administrator of the network system to perform an operation and the like to solve the degradation of communication quality.

The analysis apparatus 100 can calculate the non-accumulative data loss rate and packet retransmission rate without using the information related to a protocol that is higher than TCP, and therefore, this method can be applied to general TCP sessions.

### Second Embodiment

In the first embodiment, the analysis apparatus 100 determines communication quality of communication flows using the non-accumulative data loss rate and the packet retransmission rate. A second embodiment differs from the first embodiment in that non-accumulative rate and excess transmission rate are used for the indexes for determining communication quality of communication flows. The excess transmission rate is a rate of the packets transmitted to the destination terminal 104 after the response packets to the packets transmitted to the destination terminal 104 are discarded.

Below, the second embodiment will be explained mainly focusing on the differences from the first embodiment. The same configurations and processes as the first embodiment are given the same reference characters, and the descriptions thereof are omitted.

The configuration of the network system is the same as that of the first embodiment, and therefore, the description thereof is omitted. The hardware configuration of the analysis apparatus 100 is the same as that of the first embodiment, and therefore, the description thereof is omitted.

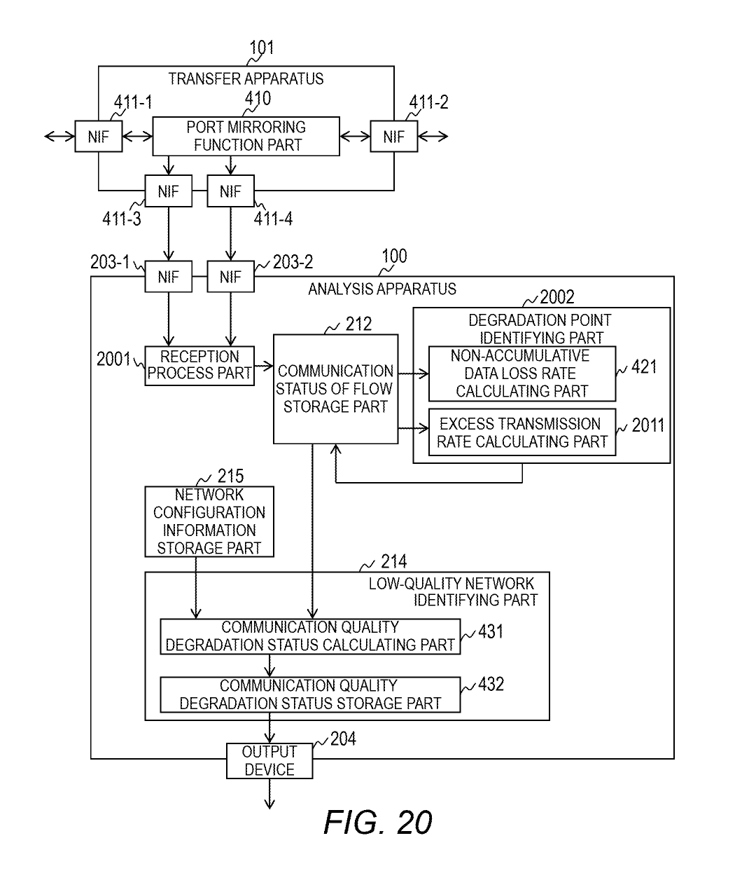

FIG. 20 is a block diagram showing the relationship between the respective function parts of the analysis apparatus 100 and the transfer apparatus 101 of the second embodiment. The transfer apparatus 101 is the same as that of the first embodiment, and therefore, the description thereof is omitted.

The main storage device 201 of the analysis apparatus 100 of the second embodiment stores therein the programs that realize the reception process part 2001, the communication status of flow storage part 212, the degradation point identifying part 2002, the low-quality network identifying part 214, and the network configuration information storage part 215. The communication status of flow storage part 212, the low-quality network identifying part 214, and the network configuration information storage part 215 are the same as those of the first embodiment, and the descriptions thereof are omitted.

The reception process part 2001 of the second embodiment differs from that of the first embodiment in that it stores the information for calculating the excess transmission rate in the communication status of flow storage part 212. In the second embodiment, the flow information stored in the communication status of flow storage part 212 partially differs from that of the first embodiment.

The degradation point identifying part 2002 of the second embodiment includes an excess transmission rate calculating part 2011 instead of the packet retransmission rate calculating part 422. The excess transmission rate calculating part 2011 calculates the excess transmission rate. The degradation point identifying part 2002 of the second embodiment 2 detects degradation of communication quality of a communication flow using the non-accumulative data loss rate and the excess transmission rate.

Here, the flow information stored in the communication status of flow storage part 212 of the second embodiment 2 will be explained. The flow information of the second embodiment is made up of three types of data structures which are session_data structure 600, capture_data structure 2100, and analysis_data structure 2200. In the second embodiment, some of the values included in the capture_data structure 2100 and the analysis_data structure 2200 differ from those of the capture_data structure 700 and the analysis_data structure 800 of the first embodiment.

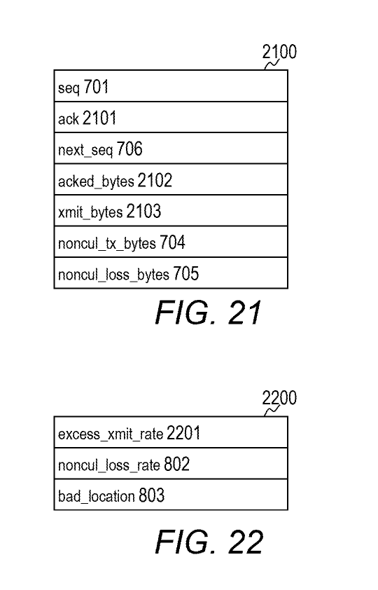

FIG. 21 is a diagram showing an example of the capture_data structure 2100 of the second embodiment. FIG. 22 is a diagram showing an example of the analysis_data structure 2200 of the second embodiment.

The capture_data structure 2100 of the second embodiment includes the seq 701, an ack 2101, the next_seq 706, an acked_bytes 2102, a xmit_bytes 2103, the noncul_tx_bytes 704, and the noncul_loss_bytes 705.

The ack 2101 is the latest confirmation response number. The acked_bytes 2102 is the byte counts of a packet that was confirmed to have reached the destination terminal 104 by the confirmation response packet. The xmit_bytes 2103 is the byte counts of a packet that was confirmed to have been sent to the destination terminal 104.

The analysis_data structure 2200 of the second embodiment includes an excess_xmit_rate 2201, the noncul_loss_rate 802, and the bad_location 803. The excess_xmit_rate 2201 is the excess transmission rate.

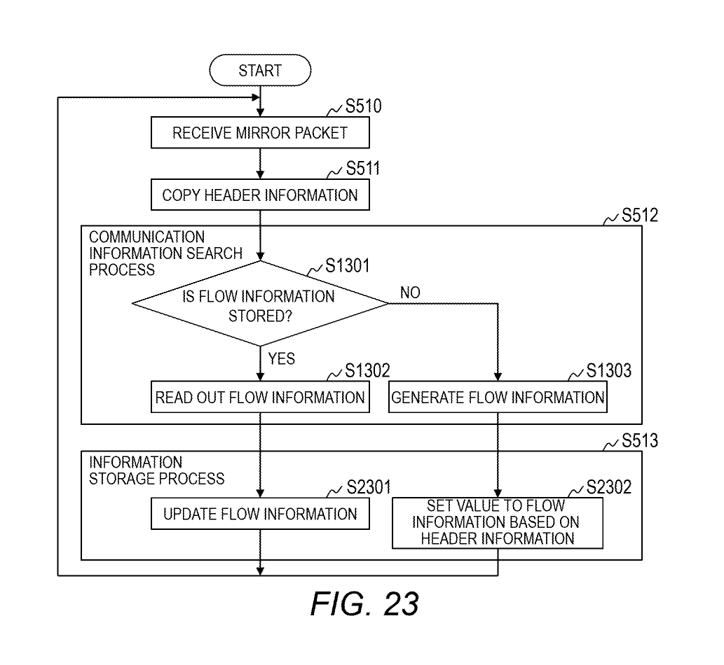

FIG. 23 is a flowchart for explaining in detail the process performed by the reception process part 2001 of the second embodiment.

Steps S510, S511, and S512 are the same as those of the first embodiment. A part of the information storage process of Step S513 of the second embodiment differs from that of the first embodiment.

The reception process part 2001 reads out the searched flow information from the communication status of flow storage part 212 (Step S1302), and updates the searched flow information (Step S2301). Then, the reception process part 2001 returns to Step S510. The process of Step S2301 is performed as described below.

The reception process part 2001 adds the payload size of the mirror packet to the xmit_bytes 2103 of the capture_data structure 700. In a case where the ACK 334 of the mirror packet is ahead of the ack 2101 of the capture_data structure 700, the reception process part 2001 adds, to the acked_bytes 2102, the value obtained by subtracting the ack 2101 from the ACK 334. The reception process part 2001 also sets the ack 2101 in the ACK 334 of the mirror packet.

The update method of the seq 701, the next_seq 706, the noncul_tx_bytes 704, and the noncul_loss_bytes 705 is the same as that of the first embodiment, and therefore, the description thereof is omitted. The process of Step S2301 is performed as described above.

The reception process part 2001 generates new flow information in the communication status of flow storage part 212 (Step S1303), and sets the flow information values (Step S2302). Then, the reception process part 2001 returns to Step S510. The process of Step S2302 is performed as described below.

The reception process part 2001 sets the payload size of the mirror packet in the xmit_bytes 2103, sets the ACK 334 of the mirror packet in the ack 2101, and sets “0” in the acked_bytes 2102.

The setting method of the seq 701, the next_seq 706, the noncul_tx_bytes 704, and the noncul_loss_bytes 705 is the same as that of the first embodiment, and therefore, the description thereof is omitted. The process of Step S2302 is performed as described above.

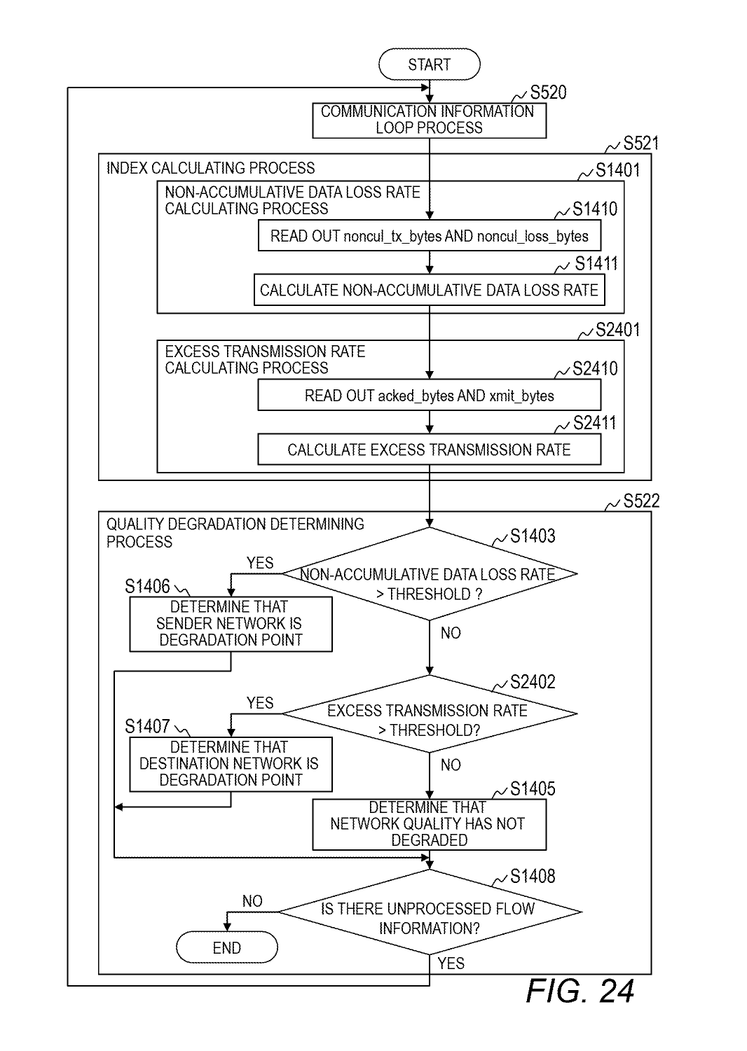

FIG. 24 is a flowchart for explaining in detail the process performed by the degradation point identifying part 2002 of the second embodiment.

The index calculating process and quality degradation determining process of the second embodiment partially differ from those of the first embodiment.

In the index calculating process, the degradation point identifying part 2002 performs a process to calculate the excess transmission rate instead of the process to calculate the packet retransmission rate (Step S2401). The process to calculate the non-accumulative data loss rate (Step S1401) is the same as that of the first embodiment.

In the excess transmission rate calculating process, first, the excess transmission rate calculating part 2011 reads out the acked_bytes 2102 and the xmit_bytes 2103 of the selected flow information from the communication status of flow storage part 212 (Step S2410). The excess transmission rate calculating part 2011 calculates the excess transmission rate based on the following equation (8) (Step S2411). The excess transmission rate calculating part 2011 stores the calculated excess transmission rate in the excess_xmit_rate 2201 of the selected flow information in the communication status of flow storage part 212.

$$\begin{matrix}[ Equation 8 ] & \\ \frac{( xmit\_bytes 2402 ) - ( acked\_bytesa2401 )}{acked\_bytesa2401} & ( 8 )\end{matrix}$$

In the quality degradation determining process, in a case where the non-accumulative data loss rate is equal to or smaller than a prescribed threshold value, the degradation point identifying part 2002 reads out the excess_xmit_rate 2201 of the selected flow information from the communication status of flow storage part 212, and determines whether the excess transmission rate is greater than a prescribed threshold value or not (Step S2402).

In a case where the excess transmission rate is greater than the prescribed threshold value, the degradation point identifying part 2002 determines that the communication quality of the communication flow has degraded, and that the network 110 of Group 2 (communication path between the destination terminal 104 and the transfer apparatus 101) is the degradation point (Step S1407). Then the degradation point identifying part 2002 proceeds to Step S1408. The degradation point identifying part 2002 stores “2” in the bad_location 803 of the selected flow information in the communication status of flow storage part 212.

The threshold value used for the determining process of Step S2402 is greater than 0 and smaller than 1. For example, “0.1” is used for the threshold value.

The value of the excess transmission rate increases if the packet is discarded, no response is received from the destination terminal, and the packet is retransmitted. That is, similar to the packet retransmission rate, the excess transmission rate is affected by the degradation of communication quality of both of the network 110-1 and the network 110-4 as shown in FIG. 15. Thus, similar to the first embodiment, the degradation point of the flow can be identified using the non-accumulative data loss rate and the excess transmission rate.

According to the second embodiment, even if a different index from the first embodiment is used, effects similar to the first embodiment can be achieved. That is, using an index that is similar to the packet loss rate and that can evaluate communication quality of a communication flow, the effects described in the first embodiment can be achieved.

### Third Embodiment

A third embodiment differs from the first embodiment in that the analysis apparatus 100 performs a control to address the degradation of communication quality based on the process results. Below, the third embodiment will be explained mainly focusing on the differences from the first embodiment. The same configurations and processes as the first embodiment are given the same reference characters, and the descriptions thereof are omitted.

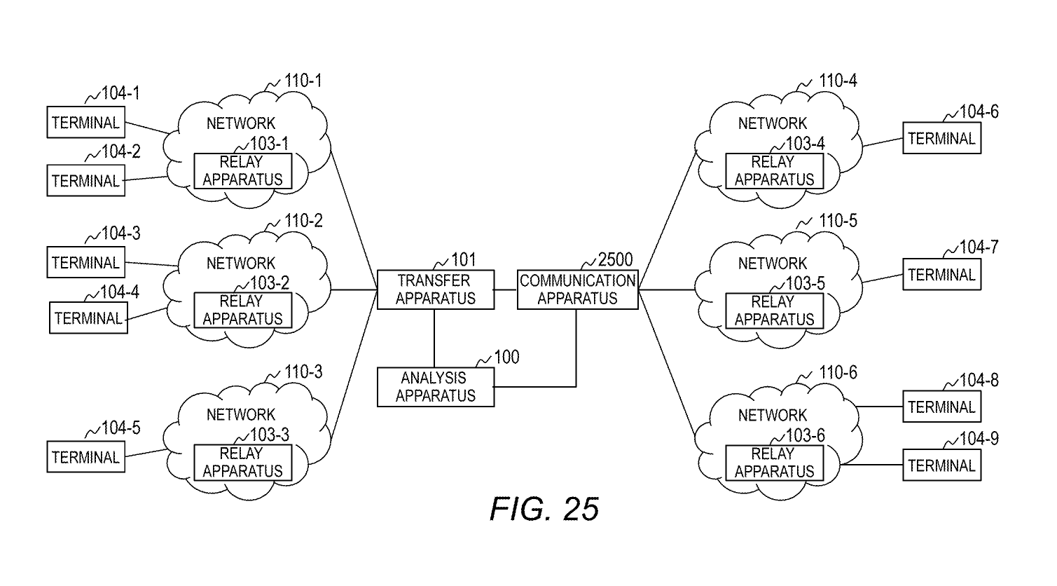

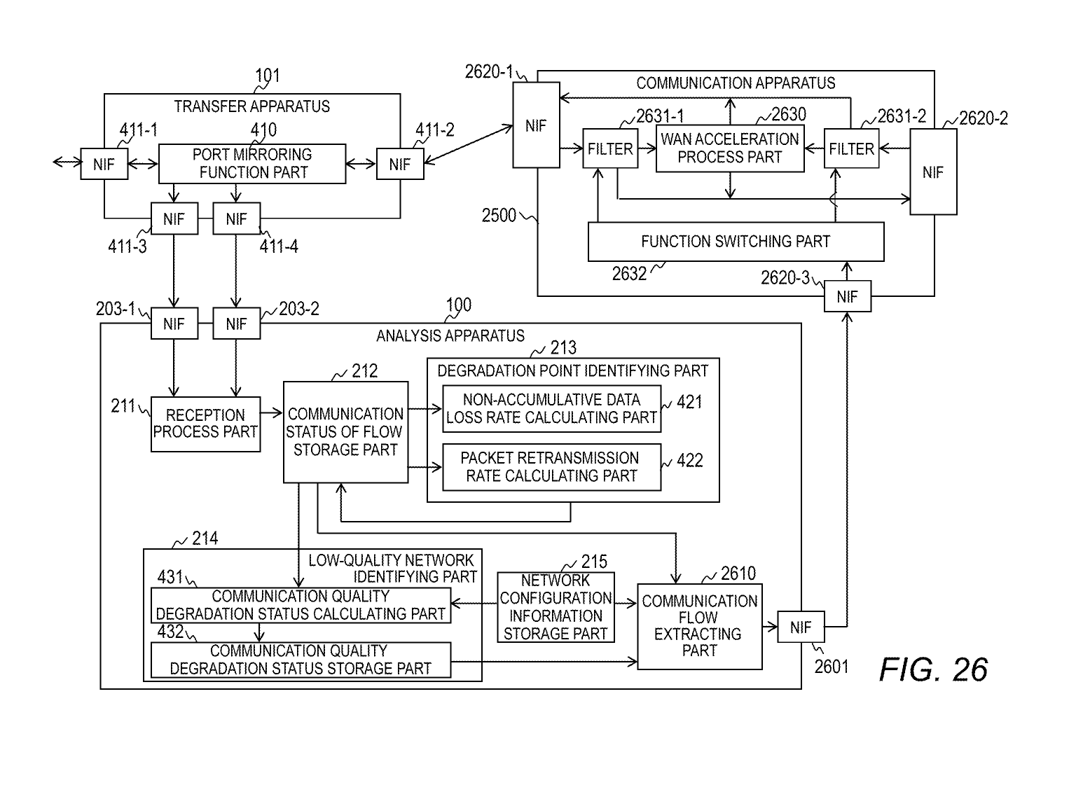

FIG. 25 is a diagram for explaining a configuration example of a network system of the third embodiment. FIG. 26 is a block diagram showing the relationship between the respective function parts of the analysis apparatus 100, the transfer apparatus 101, and a communication device 2500 of the third embodiment.

The network system of the third embodiment differs from the network system of the first embodiment in that the communication device 2500 having the WAN acceleration function is provided. The communication device 2500 is connected to the transfer apparatus 101 and the analysis apparatus 100.

The analysis apparatus 100 of the third embodiment partially differs from that of the first embodiment. Specifically, the analysis apparatus 100 has NIF 2601 for connecting to the communication device 2500 instead of the output device 204. The main storage device 201 of the analysis apparatus 100 of the third embodiment 3 stores therein a program that realizes a communication flow extracting part 2610.

The communication flow extracting part 2610 extracts a communication flow to be subjected to the acceleration function based on the process result of the low-quality network identifying part 214, flow information, and network configuration information 1100. The communication flow extracting part 2610 generates the acceleration target flow list based on the extraction result, and transmits the list to the communication device 2500 via the NIF 2601.

The communication device 2500 has three NIFs 2620. The communication device 2500 has a hardware configuration similar to that of the analysis apparatus 100 such as the processing device 200, main storage device 201, and secondary storage device 202. Furthermore, the main storage device 201 of the communication device 2500 stores therein programs for realizing a WAN acceleration process part 2630, filters 2631, and a function switching part 2632.

The WAN acceleration process part 2630 terminates the TCP communication of a packet received from the NIF 2620-1 via the filter 2631-1, and outputs the packet to the NIF 2620-2 by TCP communication that performs faster congestion control algorithm. The WAN acceleration process part 2630 also terminates the TCP communication of a packet received from the NIF 2620-2 via the filter 2631-2, and outputs the packet to the NIF 2620-1 by TCP communication that performs an algorithm known as RENO.

The function switching part 2632 controls the filters 2631-1 and 2631-2 so that the WAN acceleration function is activated and deactivated based on the acceleration target flow list received from the analysis apparatus 100 via the NIF 2620-3. Specifically, the function switching part 2632 controls the filters 2631 so that the communication flow of the acceleration target goes through the WAN acceleration process part 2630, and other communication flows do not go through the WAN acceleration process part 2630.

In a case where the packet received from the NIF 2620-1 belongs the communication flow of the acceleration target, the filter 2631-1 outputs the packet to the WAN acceleration process part 2630. In a case where the received packet does not belong to the communication flow of the acceleration target, the filter 2631-1 outputs the packet to the NIF 2620-2.

In a case where the packet received from the NIF 2620-2 belongs the communication flow of the acceleration target, the filter 2631-2 outputs the packet to the WAN acceleration process part 2630. In a case where the received packet does not belong to the communication flow of the acceleration target, the filter 2631-2 outputs the packet to the NIF 2620-1.

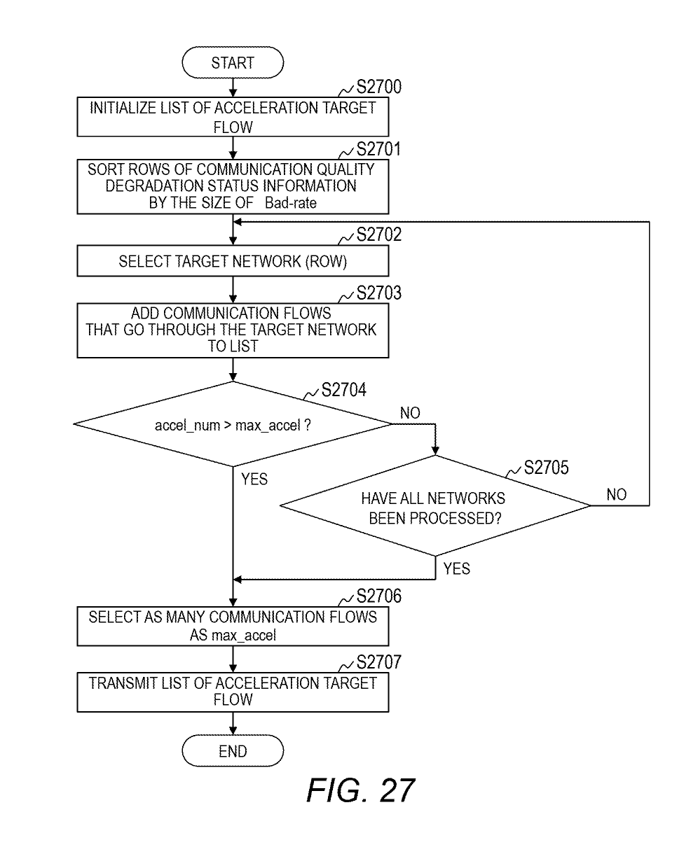

FIG. 27 is a flowchart for explaining in detail the process performed by the communication flow extracting part 2610 of the third embodiment.

The communication flow extracting part 2610 starts the following process in a case of receiving the communication quality degradation status information 1200 from the low-quality network identifying part 214. The timing at which the process of the communication flow extracting part 2610 is started is not limited to this embodiment.

The communication flow extracting part 2610 initializes the acceleration target flow list (Step S2700).

Specifically, the communication flow extracting part 2610 empties the acceleration target list, and sets “0” in the variable accel_num, which represents the number of communication flows registered in the list.

Next, the communication flow extracting part 2610 sorts the rows of the communication quality degradation status information 1200 by the values of Bad_rate 1204 in a descending order (Step S2701). The communication flow extracting part 2610 selects a target row to be processed from the communication quality degradation status information 1200, or in other words, a target network 110 to be processed (Step S2702). In this embodiment, the top row of the communication quality degradation information 1200, or in other words, the row with the largest value of Bad_rate 1204 is selected as the target network 110 to be processed.

Next, the communication flow extracting part 2610 adds all of the communication flows that go through the target network to the acceleration target flow list (Step S2703). Specifically, the process described below is performed.

The communication flow extracting part 2610 identifies all of the communication flows that go through the target network using the network ID 1101 of the target row, the flow information stored in the communication status of flow storage part 212, and the network configuration information 1100 stored in the network configuration information storage part 215. Furthermore, the communication flow extracting part 2610 adds the identification information of each identified communication flow to the acceleration target flow list. The communication flow extracting part 2610 adds the rows of respective communication flows to the end of the list.

The communication flow extracting part 2610 adds, to the variable accel_num, the number of the communication flows that were newly added to the acceleration target flow list.

Examples of the identification information of communication flows include the session_data structure 600. The process of Step S2703 is performed as described above.

Next, the communication flow extracting part 2610 determines whether the variable accel_num is greater than a max_accel, which is a threshold value, or not (Step S2704). The max_accel represents the number of communication flows that can be registered in the acceleration target flow list. The max_accel is set to a value that does not exceed the maximum number of the communication flows that can be controlled by the WAN acceleration process part 2630 at the same time, which is “10000,” for example.

In a case where the variable accel_num is greater than the max_accel, the communication flow extracting part 2610 proceeds to Step S2706.

In a case where the variable accel_num is equal to or smaller than the max_accel, the communication flow extracting part 2610 determines whether all of the networks 110 have been processed or not (Step S2705). That is, the communication flow extracting part 2610 determines whether all of the rows of the communication quality degradation status information 1200 have been processed or not.

In a case where all of the networks 110 have been processed, the communication flow extracting part 2610 proceeds to Step S2706. On the other hand, in a case where all of the networks 110 have not yet been processed, the communication flow extracting part 2610 returns to Step S2702, and the processes described above are performed. In this case, in Step S2702, the network 110 with the largest Bad_rate 1204 next to the network 110 that was selected previously is selected.

In Step 2706, the communication flow extracting part 2610 selects as many communication flows as the max_accel from the communication flows included in the acceleration target flow list, and registers the selected communication flows in the acceleration target flow list (Step S2706).

The communication flow extracting part 2610 transmits the acceleration target flow list to the communication device 2500 (Step S2707), and then ends the process.

According to the third embodiment, the communication device 2500 can dynamic control to the degradation of communication quality based on the process result of the analysis apparatus 100. In a case where the number of communication flows that can be controlled by the WAN acceleration process part 2630 is limited, it is possible to efficiently utilize the WAN acceleration process part 2630, because the communication device 2500 can preferentially control the communication flows that go through a network 110 with a greater value of Bad_rate 1204.

### Fourth Embodiment

A fourth embodiment differs from the first embodiment in that the transfer apparatus 101 has the functions of the analysis apparatus 100. Below, the fourth embodiment will be explained mainly focusing on the differences from the first embodiment. The same configurations and processes as the first embodiment are given the same reference characters, and the descriptions thereof are omitted.

The network system of the fourth embodiment differs from the network system of the first embodiment in that the analysis apparatus 100 is not included.

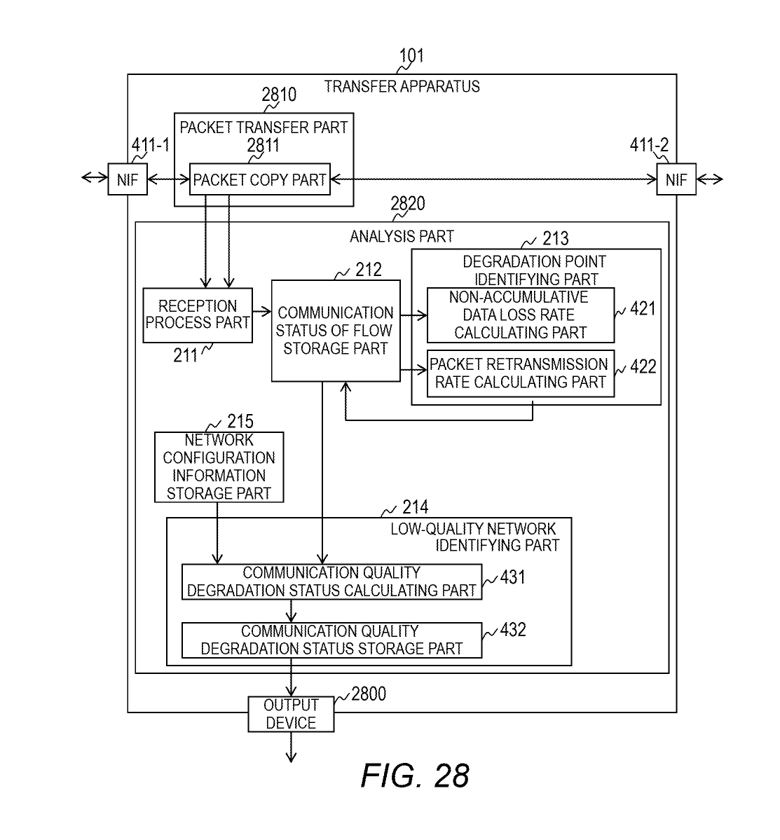

FIG. 28 is a block diagram showing the relationship between the respective function parts of the transfer apparatus 101 of the fourth embodiment.

The transfer apparatus 101 of the fourth embodiment has an output device 2800. The output device 2800 is the same as the output device 204. The main storage device 201 of the transfer apparatus 101 of the fourth embodiment stores therein programs that realize a packet transfer part 2810 and an analysis part 2820.

The packet transfer part 2810 transmits, through one NIF 411, the packet received via the other NIF 411. The packet transfer part 2810 copies the received packet to the main storage device 201, and outputs the copied packet to the reception process part 211 of the analysis part 2820 as a mirror packet. The main storage device 201 includes a buffer for copying the packet received from the NIF 411-1 and a buffer for copying the packet received from the NIF 411-2. The reception process part 211 determines the flow direction of the packet by identifying the buffer with which the packet was copied.

The analysis part 2820 is a function part that realizes the functions of the analysis apparatus 100. The analysis part 2820 includes the reception process part 211, the communication status of flow storage part 212, the degradation point identifying part 213, the low-quality network identifying part 214, and the network configuration information storage part 215.

The configurations and processes of the reception process part 211, the communication status of flow storage part 212, the degradation point identifying part 213, the low-quality network identifying part 214, and the network configuration information storage part 215 are the same as those of the first embodiment, and therefore, the descriptions thereof are omitted.

According to the fourth embodiment, the transfer apparatus 101 includes the analysis part 2820, and therefore, effects similar to those of the first embodiment can be achieved without changing the configuration of the network system.

In the fourth embodiment, the transfer apparatus 101 includes the analysis part 2820, but the present invention is not limited to this. Other network devices that control the communication between the respective terminals 104 in the network system such as the relay apparatus 103 and the communication device 2500 may have the analysis part 2820.

In the first embodiment to the fourth embodiment 4, communication flows between physical terminals 104 were subjected to the process, but the present invention is not limited to this. For example, virtual terminals may be realized on one computer, and a similar configuration may be applied to communication flows between the plurality of virtual terminals. In this case, the transfer apparatus 101 is realized as a transfer function part, for example. The transfer function part is realized by the processing device 200 executing a program stored in the main storage device 201 of the processing device 200.

The description of the embodiment is directed to the example of using the control by hardware, but it is also possible to realize a part thereof by software.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit.

The above-described configurations and functions may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings shows control lines and information lines as considered necessary for explanation but do not show all control lines or information lines in the products. It can be considered that almost of all components are actually interconnected.

What is claimed is:

1. A network system comprising a plurality of network apparatuses,
wherein each of the plurality of network apparatuses include a processing device, and a storage device coupled to the processing device,
wherein the network system comprises:
a transfer function part configured to transfer packets that flow through a communication flow which is a control unit of a communication between terminals; and
an analysis part configured to analyze a communication status of the communication flow,
wherein the transfer function part and the analysis part are realized by the processing device of at least one of the plurality of network apparatuses executing programs stored in the storage device,
wherein the analysis part includes:
a reception process part configured to receive packets belonging to a given communication flow from the transfer function part, and generate and update flow information that is management information on the communication flow based on an analysis result of header information on the packets;
a communication status of flow storage part configured to store the flow information on each of a plurality of communication flows; and
a degradation point identifying part configured to detect degradation of communication quality of the each of the plurality of communication flows, and identify a degradation point on a communication path of the communication flow having quality degradation,
wherein the degradation point identifying part includes an index calculating part configured to calculate a plurality of indexes that are similar to a packet loss rate, the plurality of indexes requiring a smaller amount of data for an analysis and therefore requiring a shorter period of time for calculation, and
wherein the degradation point identifying part is configured to:
determine whether communication quality of the communication flow has degraded or not based on the plurality of indexes calculated by the index calculating part; and
identify the degradation point on a communication path which is gone through a communication flow having degradation in the communication quality, based on the plurality of indexes calculated by the index calculating part.

2. The network system according to claim 1,
wherein the index calculating part is configured to:
calculate, as the plurality of indexes, a non-accumulative data loss rate that is a packet loss rate related only to a packet that includes a certain type of data and that is transmitted from a sender terminal for the first time, and a packet retransmission rate that is a rate of packets that are retransmitted to a destination terminal, or
calculate, as the plurality of indexes, the non-accumulative data loss rate and an excess transmission rate that is a rate of packets that are retransmitted in accordance with a discarding of response packets transmitted from the destination terminal.

3. The network system according to claim 2,
wherein the degradation point identifying part is configured to:
read out the flow information on a target communication flow from the flow communication status storage part;
calculate the non-accumulative data loss rate and the packet retransmission rate, or the non-accumulative data loss rate and the excess transmission rate, based on the flow information on the target communication flow;
determine whether the non-accumulative data loss rate is greater than a prescribed threshold value or not;
determine that communication quality of the target communication flow degrade in a case where the non-accumulative data loss rate is greater than the prescribed threshold value, and identify, as the degradation point, a communication path between the sender terminal and the network apparatus that relays the packet;
determine whether the packet retransmission rate or the excess transmission rate is greater than a prescribed threshold value or not in a case where the non-accumulative data loss rate is equal to or smaller than the prescribed threshold value, and
determine that communication quality of the target communication flow degrade in a case where the packet retransmission rate or the excess transmission rate is greater than the prescribed threshold value; and identify, as the degradation point, a communication path between the network apparatus that relays the packet and the destination terminal.

4. The network system according to claim 1,
wherein the network system includes a plurality of networks,
wherein each terminal is coupled to the network apparatus having the transfer function part through at least one of the plurality of networks,
wherein the degradation point identifying part is configured to store a process result of the target communication flow in the flow communication status storage part, and
wherein the analysis part includes a low-quality network identifying part configured to generate communication quality degradation status information that is information for identifying a network having a cause of degradation of the communication quality in the network system, based on a process result of the degradation point identifying part.

5. The network system according to claim 4,
wherein the low-quality network identifying part is configured to:
calculate, for each of the plurality of networks, a ratio of the communication flows deemed to have degradation of communication quality among the plurality of communication flows flowing a network, based on a process result of the degradation point identifying part for each of the plurality of communication flows; and
generate the ratio of each of the plurality of networks as the communication quality degradation status information.

6. A method for determining communication quality in a network system including a plurality of network apparatuses,
wherein each of the plurality of network apparatuses has a processing device and a storage device coupled to the processing device;
wherein the network system includes:
a transfer function part configured to transfer packets that flow through a communication flow which is a control unit of a communication between terminals; and
an analysis part configured to analyze a communication status of the communication flow,
wherein the transfer function part and the analysis part are realized by the processing device of at least one of the plurality of network apparatuses executing a program stored in the storage device,
wherein the analysis part includes an index calculating part configured to calculate a plurality of indexes that are similar to a packet loss rate and that require a smaller amount of data for an analysis and therefore require a shorter period of time for calculation,
wherein the method for determining communication quality includes:
a first step of receiving, by the analysis part, packets belonging to a given communication flow from the transfer function part, and generating and updating flow information that is management information on the communication flow based on an analysis result of header information on the packets;
a second step of storing, by the analysis part, the flow information on each of a plurality of communication flows; and
a third step of detecting, by the analysis part, degradation of communication quality of the each of the plurality of communication flows based on the flow information, and identifying a degradation point on a communication path of the communication flow having quality degradation, and
wherein the third step includes steps of:
determining, by the analysis part, whether communication quality of the communication flow has degraded or not based on the plurality of indexes calculated by the index calculating part; and
identifying, by the analysis part, the degradation point on a communication path which is gone through a communication flow having degradation in the communication quality, based on the plurality of indexes calculated by the index calculating part.

7. The method for determining communication quality according to claim 6,
wherein the index calculating part calculates, as the plurality of indexes, a non-accumulative data loss rate that is a packet loss rate related only to a packet that includes a certain type of data and that is transmitted from a sender terminal for the first time, and a packet retransmission rate that is a rate of packets that are retransmitted to a destination terminal, or the non-accumulative data loss rate and an excess transmission rate that is a rate of packets that are retransmitted in accordance with a discarding of response packets transmitted from the destination terminal.

8. The method for determining communication quality according to claim 7,
wherein the third step includes steps of:
reading out, by the index calculating part, the flow information on a target communication flow from a plurality of pieces of the flow information on the plurality of communication flows stored in the analysis part;
calculating, by the index calculating part, the non-accumulative data loss rate and the packet retransmission rate, or the non-accumulative data loss rate and the excess transmission rate, based on the flow information on the target communication flow;
determining, by the analysis part, whether the non-accumulative data loss rate is greater than a prescribed threshold value or not;
determining, by the analysis part, that communication quality of the target communication flow degrade in a case where the non-accumulative data loss rate is greater than the prescribed threshold value, and identifying, as the degradation point, a communication path between the sender terminal and the network apparatus that relays the packet;
determining, by the analysis part, whether the packet retransmission rate or the excess transmission rate is greater than a prescribed threshold value or not in a case where the non-accumulative data loss rate is equal to or smaller than the prescribed threshold value; and
determining, by the analysis part, that communication quality of the target communication flow degrade in a case where the packet retransmission rate or the excess transmission rate is greater than the prescribed threshold value, and identifying, as the degradation point, a communication path between the network apparatus that relays the packet and the destination terminal.

9. The method for determining communication quality according to claim 6,
wherein the network system includes a plurality of networks,
wherein each terminal is coupled to the network apparatus having the transfer function part through at least one of the plurality of networks,
wherein the method for determining communication quality further includes:
a fourth step of storing, by the analysis part, a result of a process performed on the target communication flow; and
a fifth step of generating, by the analysis part, communication quality degradation status information that is information for identifying a network having a cause of degradation of communication quality in the network system based on a result of a process performed on the plurality of communication flows.

10. The method for determining communication quality according to claim 9,
wherein the fifth step includes steps of:
calculating, by the analysis part, a ratio of communication flows deemed to have degradation of communication quality among the plurality of communication flows flowing a network, based on a result of a process performed on the plurality of communication flows; and
generating, by the analysis part, the ratio of each of the plurality of networks as the communication quality degradation status information.

11. An analysis apparatus configured to analyze a packet received from a transfer apparatus that couples a plurality of terminals in a network system, comprising:
a processing device;
a storage device coupled to the processing device;
a reception process part configured to receive packets belonging to a given communication flow that is a control unit of a communication between terminals from the transfer apparatus, and generate and update flow information that is management information on the communication flow based on an analysis result of header information on the packet;
a communication status of flow storage part configured to store the flow information on each of a plurality of communication flows; and
a degradation point identifying part configured to detect degradation of communication quality of the each of the plurality of communication flows based on the flow information, and identify a degradation point on a communication path of the communication flow having quality degradation,
wherein the degradation point identifying part includes an index calculating part configured to calculate a plurality of indexes that are similar to a packet loss rate and that require a smaller amount of data for analysis and therefore require a shorter period of time for calculation, and
wherein the degradation point identifying part is configured to:
determine whether the communication quality of the communication flow has degraded or not based on the plurality of indexes calculated by the index calculating part; and
identify the degradation point on a communication path which is gone through a communication flow having degradation in the communication quality, based on the plurality of indexes calculated by the index calculating part.

12. The analysis apparatus according to claim 11,
wherein the index calculating part is configured to:
calculate, as the plurality of indexes, a non-accumulative data loss rate that is a packet loss rate related only to a packet that includes a certain type of data and that is transmitted from a sender terminal for the first time, and a packet retransmission rate that is a rate of packets that are retransmitted to a destination terminal, or
calculate, as the plurality of indexes, the non-accumulative data loss rate and an excess transmission rate that is a rate of packets that are retransmitted in accordance with a discarding of response packets transmitted from the destination terminal.

13. The analysis apparatus according to claim 12,
wherein the degradation point identifying part is configured to:
read out the flow information on a target communication flow from the flow communication status storage part,
calculate the non-accumulative data loss rate and the packet retransmission rate, or the non-accumulative data loss rate and the excess transmission rate, based on the flow information on the target communication flow,
determine whether the non-accumulative data loss rate is greater than a prescribed threshold value or not,
determine that communication quality of the target communication flow degrade in a case where the non-accumulative data loss rate is greater than the prescribed threshold value, and identify, as the degradation point, a communication path between the sender terminal and the network apparatus that relays the packet,
determine whether the packet retransmission rate or the excess transmission rate is greater than a prescribed threshold value or not in a case where the non-accumulative data loss rate is equal to or smaller than the prescribed threshold value, and
determine that communication quality of the target communication flow degrade in a case where the packet retransmission rate or the excess transmission rate is greater than the prescribed threshold value, and identify, as the degradation point, a communication path between the network apparatus that relays the packet and the destination terminal.

14. The analysis apparatus according to claim 11,
wherein each of the plurality of terminals is coupled to the transfer apparatus via at least one of a plurality of networks,
wherein the destination point identifying part is configured to store a process result of the target communication flow in the flow communication status storage part, and
wherein the analysis apparatus further includes a low-quality network identifying part configured to generate communication quality degradation status information that is information for identifying a network having a cause of degradation of the communication quality in the network system based on a process result of the degradation point identifying part.

15. The analysis apparatus according to claim 14,
wherein the low-quality network identifying part is configured to:
calculate, for each of the plurality of networks, a ratio of communication flows deemed to have degradation of communication quality among the plurality of communication flows flowing a network, based on a process result of the degradation point identifying part for each of the plurality of communication flows; and
generate, as the communication quality degradation status information, the ratio of each of the plurality of networks.
